(19) United States
(12) Patent Application Publication
(10) Pub. No.: US 2016/0356414 A1
(43) Pub. Date: Dec. 8, 2016

(54) DISPLAY DEVICE

(71) Applicant: SAMSUNG ELECTRONICS CO., LTD., Suwon-si (KR)

(72) Inventors: Jun-ki NOH, Suwon-si (KR); Jong-pil SEO, Suwon-si (KR); Nam-gi LEE, Hwaseong-si (KR); Woo-sung IN, Hwaseong-si (KR); Chi-woo LEE, Seoul (KR)

(21) Appl. No.: 15/067,479

(22) Filed: Mar. 11, 2016

Related U.S. Application Data
(60) Provisional application No. 62/170,944, filed on Jun. 4, 2015.

(30) Foreign Application Priority Data
Aug. 5, 2015 (KR) 10-2015-0110708

(51) Int. Cl. F16M 11/10; H04N 5/64; H04N 5/60; H04N 5/655

(52) U.S. Cl. CPC F16M 11/10; H04N 5/655; H04N 5/642; H04N 5/602

(57) ABSTRACT

A display device is provided, which includes a main body, and a drive body electrically connected to the main body and configured to support the main body so as to rotate the main body leftward and rightward, wherein the drive body includes an upper plate that ascends and descends.

### CROSS-REFERENCE TO RELATED APPLICATIONS

This application is based on and claims priority under 35 U.S.C. §119 to Korean Patent Application No. 10-2015-0110708 filed on Aug. 5, 2015 in the Korean Intellectual Property Office, and U.S. Provisional Patent Application No. 62/170,944 filed on Jun. 4, 2015 in the United States Patent and Trademark Office, the disclosures of which are incorporated by reference herein in their entireties.

### BACKGROUND

Field

The disclosure relates to a display device, and for example, to a display device, which enables a TV body to ascend, descend, or rotate leftward or rightward using a stand, which may, for example, generally have a form of a cube, that supports a large-scale TV.

Description of Related Art

Aside from the existing curved or bendable flat panel display, a modified display device that is mounted with a motor or a drive body has recently been released. In particular, as the display device becomes large-sized, it is required that the drive body has an appropriate size and an appropriate weight in order to stably support, move, and rotate a display screen in predetermined directions, and also takes charge of a partial function of a TV.

### SUMMARY

Example embodiments of the disclosure overcome the above disadvantages and other disadvantages not described above, and provide a display device, in which a drive portion is provided in a drive body that is electrically connected to a TV main body in order to stably support, move, and rotate the TV main body in predetermined directions, and may also include, for example, a woofer speaker and a power portion, which are weighted constituent elements provided in the TV main body, that may be included in the drive body to secure the self-weight of the drive body.

According to an example of the disclosure, a display device includes: a main body of the display device; and a drive body electrically connected to the main body and configured to support the main body to rotate the main body leftward and rightward, wherein the drive body includes an upper plate that supports the device main body and is configured to ascend and descend. For example, the upper plate can ascend if a power of the main body is turned on.

The main body may include a signal processor configured to process a signal and to output audio and video signals; a first speaker configured to output the audio signal; a display panel configured to display the video signal; and a controller configured to control the main body and the drive body.

The drive body may include a shaft cover configured to guide movement of the upper plate; and a shaft positioned in the shaft cover and coupled to a support member and configured to rotate the main body. The drive body may further include a second speaker configured to output the audio signal that is output from the main body; and a power portion located on left and right sides of the second speaker to supply a power to the main body and the drive body.

The power portion may comprise a first power board that may be located in parallel to a left plate or a right plate of the drive body. The drive body may include a lower plate, and at least one hole may be formed in the lower plate and configured for discharging sound that is output from the second speaker to an outside of the drive body. No hole may be formed on a front plate, a left plate, and a right plate of the drive body. A rear plate of the drive body may be coupled to the drive body using a magnet.

The drive body may further include a light emitting portion, an upper portion of the drive body may be coupled to the light emitting portion, and the light emitting portion may be configured to emit light during movement of the upper plate. An upper plate cover may be fastened to the upper plate using a magnet. The drive body may further include a weight body. The weight of the weight body may be determined by a size of the main body and a weight of the second speaker included in the drive body.

At least one of a power cable, an audio signal cable, and a data cable may be located inside the shaft cover.

The drive body may include a drive portion, and the drive portion may include a first actuator configured to move the upper plate, and a second actuator configured to rotate the shaft. One side of the shaft may be coupled to a worm gear, and the worm gear may be coupled to a dummy gear that supports the shaft. A reinforcement member for supporting the shaft may be arranged around the second actuator and the shaft.

The main body may further include a rear cover, and a hole that is directed in a vertical direction may be formed on the rear cover. The first speaker may be arranged at a lower end of the main body.

A circuit board that includes the signal processor or the controller may be located in a center portion of the main body.

The second speaker may process bass sound and may discharge sound to an outside through the hole formed on the lower plate of the drive body.

According to another example of the disclosure, a display device includes: a main body provided with a display panel; and a drive body electrically connected to the main body and arranged on a lower side of the main body, wherein the drive body includes an upper plate provided on an upper portion thereof, said upper plate configured to ascend and descend, and the drive body is configured to emit light through a gap between an upper end of the drive body and the upper plate when the upper plate ascends.

The upper plate may include a light emitting portion that is coupled along an edge of a bottom surface of the upper plate.

The upper plate may be configured to ascend when a power of the main body is turned on, and the light emitting portion may be configured to emit light when the upper plate ascends.

The drive body may include a shaft configured to support a rear surface of the main body; and a drive portion configured to make the upper plate ascend and descend and to rotate the shaft leftward and rightward.

The drive body may include a shaft cover configured to cover the shaft and to guide ascending and descending of the upper plate; a support member connected to a rear surface of the main body; and a connection member configured to connect the shaft and the support member to each other.

It is preferable that a through-hole that is penetrated by the connection member is formed in the shaft cover, and the width of the through-hole is wider than the width of the connection member.

The main body may include a rear cover provided in the rear thereof to cover a rear chassis, wherein the rear cover includes first to third holes for dissipating heat that is generated from the inside of the main body to an outside of the main body.

It is preferable that the first to third holes are formed in an upper portion and a lower portion of the rear cover along the width direction of the rear cover, and are directed in different directions.

A pair of first speakers may be arranged on left and right sides of a lower portion of the inside of the main body, and a single second speaker may be arranged in the center of a lower portion of the inside of the drive body.

The main body may be provided with a rear cover in which a plurality of holes for dissipating heat that is generated inside the main body to an outside of the main body are formed, and some of the plurality of holes may be formed on a lower portion of the rear cover to correspond to a height at which the first speaker is positioned.

The second speaker may be arranged so that a center of gravity of the drive body is set to a lower portion of a center of the drive body.

The display device according to an example of the disclosure may further include a sensor portion including sensor circuitry arranged around the shaft to sense rotation of the shaft.

The sensor portion may include a switch board fixed to one side of the shaft; and a first sensor installed on the switch board to detect a distance to a structure around the switch board based on the rotation of the shaft. The first sensor may, for example, be any one of a proximity sensor, an optical sensor, an ultrasonic sensor, and an infrared sensor.

The sensor portion may further include a second sensor installed on the switch board to limit a maximum angle of leftward and rightward rotation of the shaft. The second sensor may be a limit sensor that operates with a part thereof configured to interfere with a structure around the switch board in accordance with the rotation operation of the shaft.

According to still another example of the disclosure, a display device includes: a main body including a signal processor configured to output audio and video signals, a display panel configured to display the video signal, and a controller; a drive body electrically connected to the main body and configured to rotate the main body leftward and rightward and to support the main body; and an upper plate configured to form an upper surface of the drive body and to ascend or descend in accordance with occurrence of an event. The event may occur through power-on/off of the display device or a user input.

According to still another example of the disclosure, a display device includes: a main body provided with a display panel; a drive body electrically connected to the main body and configured to rotate the main body leftward and rightward and to support the main body; and an upper plate configured to form an upper surface of the drive body and to ascend or descend to be separated from the drive body.

According to still another example of the disclosure, a display device includes: a main body including a signal processor, a first speaker, a display, and a controller; a drive body coupled to the main body and including a drive portion configured to rotate the main body leftward and rightward on the basis of a signal output from the controller, a power portion configured to supply a power to the main body, a second speaker configured to output an audio signal output from the signal processor, and a light emitting portion configured to emit light on the basis of a signal output by the the controller; and an upper plate configured to form an upper surface of the drive body and to ascend or descend to be separated from the drive body, wherein the light emitting portion emits light when the upper plate ascends.

Additional and/or other aspects and advantages of the disclosure will be set forth in part in the description which follows and, in part, will be apparent from the description.

### BRIEF DESCRIPTION OF THE DRAWINGS

The above and/or other aspects of the disclosure will be more apparent from the following detailed description, taken in conjunction with the accompanying drawings, in which like reference numerals refer to like elements, and wherein:

FIG. 1 is a view illustrating an example configuration of an example display device;

FIG. 2A is a front view illustrating an example display device;

FIG. 2B is a block diagram illustrating an example display device;

FIGS. 3A and 3B are views illustrating an example upper surface and an example side surface of a display device;

FIG. 4A is a view illustrating a front surface of an example display device in a state where a display panel is removed;

FIGS. 4B to 4G are views illustrating a rear surface of an example display device;

FIG. 5 is a view illustrating an example drive body that supports a main body of a display device;

FIG. 6A is an exploded perspective view illustrating an example connection structure between a support member and a shaft;

FIG. 6B is a cross-sectional view taken along line F-F illustrated in FIG. 5;

FIG. 7 is a view illustrating an inside of an example drive body;

FIG. 8 is a view illustrating an inside of an example drive body as seen from the front;

FIG. 9 is a view illustrating an inside of an example drive body as seen from the rear;

FIG. 10A is a view illustrating an upper surface of an example upper plate;

FIG. 10B is a view illustrating a lower surface of an example upper plate and an example light emitting portion;

FIG. 10C is a perspective view of an example upper plate and an example light emitting portion as seen from the side;

FIG. 10D is a perspective view of an example upper plate and an example light emitting portion as seen from the lower side;

FIG. 10E is an exploded perspective view of an example upper plate and an example light emitting portion;

FIG. 11 is a view illustrating a lower plate and a main portion of an example drive body;

FIG. 12 is a view illustrating an inside of an example drive body;

FIG. 13 is a view illustrating surroundings of a shaft of an example drive body;

FIG. 14 is a view illustrating side surfaces of an example lifter and an example first actuator;

FIG. 15 is a view illustrating an example lifter and an example first actuator;

FIG. 16 is a view illustrating an example shaft and an example reinforcement member;

FIG. 17 is an enlarged view of surroundings of an example worm gear;

FIG. 18 is a flowchart illustrating an example process in which an upper plate ascends in an example display device;

FIG. 19 is a view illustrating an example shaft and an example switch board arranged around the shaft;

FIG. 20 is an enlarged view illustrating surroundings of an example switch board;

FIG. 21 is a view illustrating an example switch board;

FIG. 22 is a view illustrating a distance between step portions according to the position of an example switch board;

FIG. 23 is a view illustrating output values of an example proximity sensor in accordance with rotation of a switch board; and

FIG. 24 is a flowchart illustrating an example process in which a shaft is set to a center position.

### DETAILED DESCRIPTION

Various examples of the disclosure will be described with reference to the accompanying drawings. It should be understood that the disclosure is not limited to the example embodiments described hereinafter, but includes various modifications, equivalents, and/or alternatives of the examples of the disclosure. In relation to explanation of the drawings, similar drawing reference numerals may be used for similar constituent elements.

In the description, the term “has”, “may have”, “includes” or “may include” indicates existence of a corresponding feature (e.g., a numerical value, a function, an operation, or a constituent element such as a component), but does not exclude existence of an additional feature.

In the description, the term “A or B”, “at least one of A or/and B”, or “one or more of A or/and B” may include all possible combinations of the items that are enumerated together. For example, the term “A or B” or “at least one of A or/and B” may designate (1) at least one A, (2) at least one B, or (3) both at least one A and at least one B.

In the description, the terms “first, second, and so forth” are used to describe diverse elements regardless of their order and/or importance and to discriminate one element from other elements, but are not limited to the corresponding elements. For example, a first user appliance and a second user appliance may indicate different user appliances regardless of their order or importance. For example, without departing from the scope of the disclosure, the first element may be called the second element, and the second element may be called the first element in a similar manner.

If it is described that a certain element (e.g., first element) is “operatively or communicatively coupled with/to” or is “connected to” another element (e.g., second element), it should be understood that the certain element may be connected to the other element directly or through still another element (e.g., third element). If it is described that a certain element (e.g., first element) is “directly coupled to” or “directly connected to” another element (e.g., second element), it may be understood that still another element (e.g., third element) does not exist between the certain element and the other element.

In the description, the term “configured to” may be changed to, for example, “suitable for”, “having the capacity to”, “designed to”, “adapted to”, “made to”, or “capable of” under certain circumstances. The wording “configured to” may not necessarily denote or refer to “specifically designed to” in hardware. Under certain circumstances, the term “device configured to” may refer to “device capable of” doing something together with another device or components. For example, the phrase “processor configured to perform A, B, and C” may denote or refer to a dedicated processor (e.g., embedded processor) for performing the corresponding operations or a generic-purpose processor (e.g., CPU or application processor) that can perform the corresponding operations through execution of one or more software programs stored in a memory device.

The terms used in the description are used to merely describe various examples, but is not intended to limit the scope of other examples. In the disclosure, a singular expression may include a plural expression unless specially described. All terms (including technical and scientific terms) used in the description could be used as commonly understood by those ordinary skilled in the art to which the disclosure belongs. The terms that are used in the disclosure and are defined in a general dictionary may be used as meanings that are identical or similar to the meanings of the terms from the context of the related art, and they are not interpreted ideally or excessively unless they have been clearly and specially defined. Even the wordings that are defined in the present disclosure must not be interpreted to exclude all examples of the disclosure.

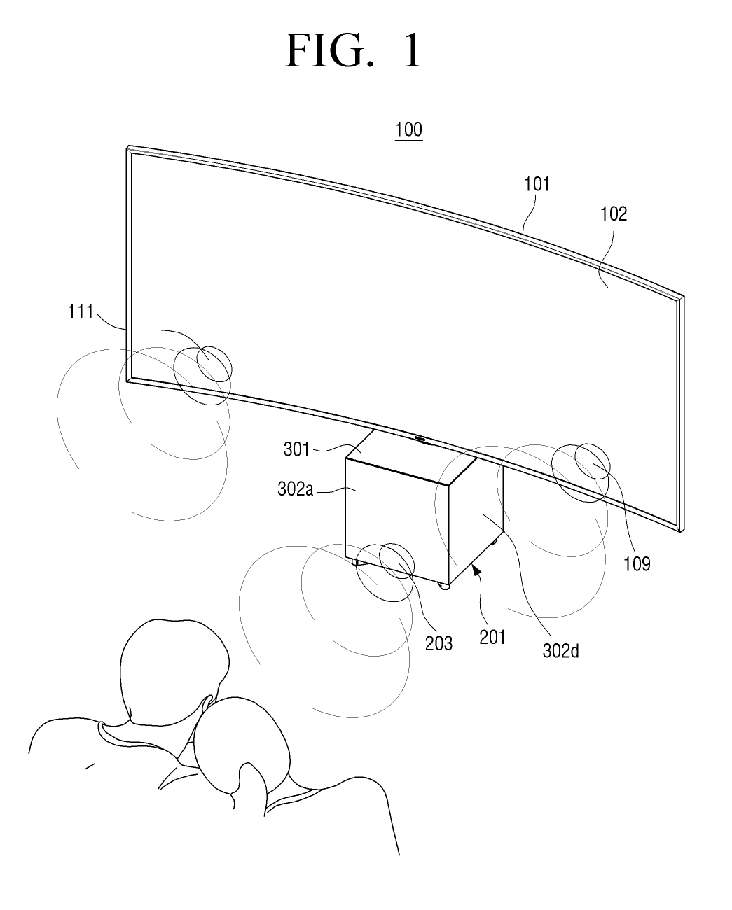

FIG. 1 is a view illustrating the configuration of an example display device.

Referring to FIG. 1, a display device 100 may include a main body 101, and a drive body 201 that supports and rotates the main body 101. The main body 101 may, for example, include a display panel 102 and first speakers 109 and 111. The display panel 102 displays a screen, and may be curved or may be flat. The first speakers may include a right speaker 109 and a left speaker 111. The right speaker 109 and the left speaker 111 may be located at a lower end of the main body, and in this case, the right speaker 109 and the right speaker 111 may be symmetrically located about the center of the display panel 102. Since the right speaker 109 and the left speaker 111 are positioned at the lower end of the main body 101 and are located in symmetrical positions, the weight center of the main body 101 can be positioned in the lower end portion, and thus the posture of the main body 101 can be stably maintained.

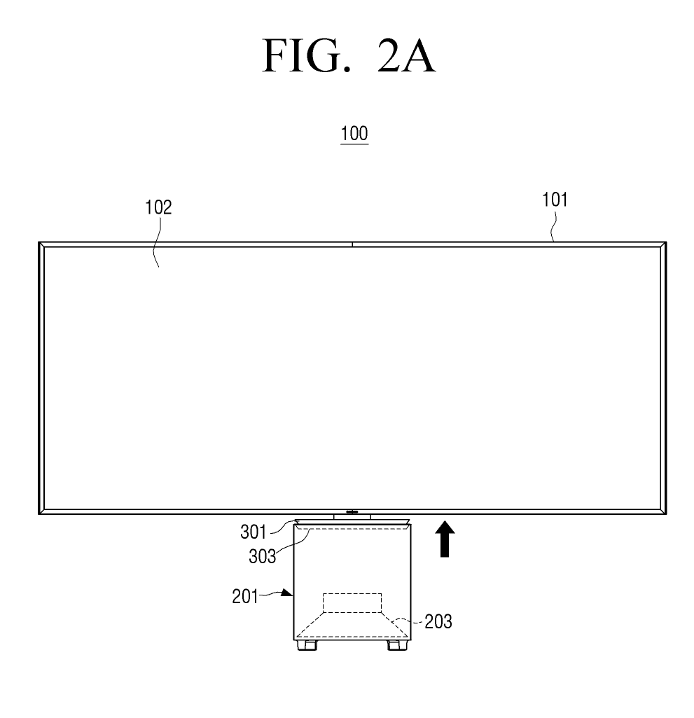

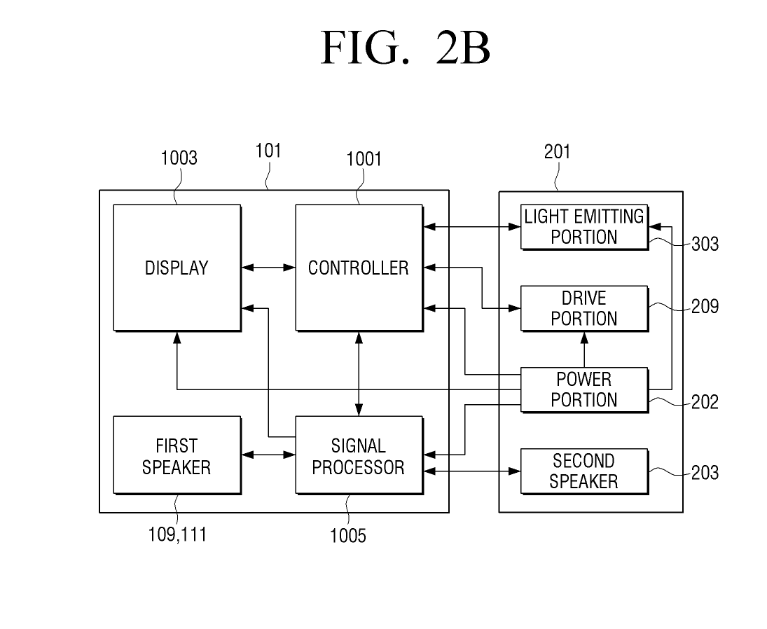

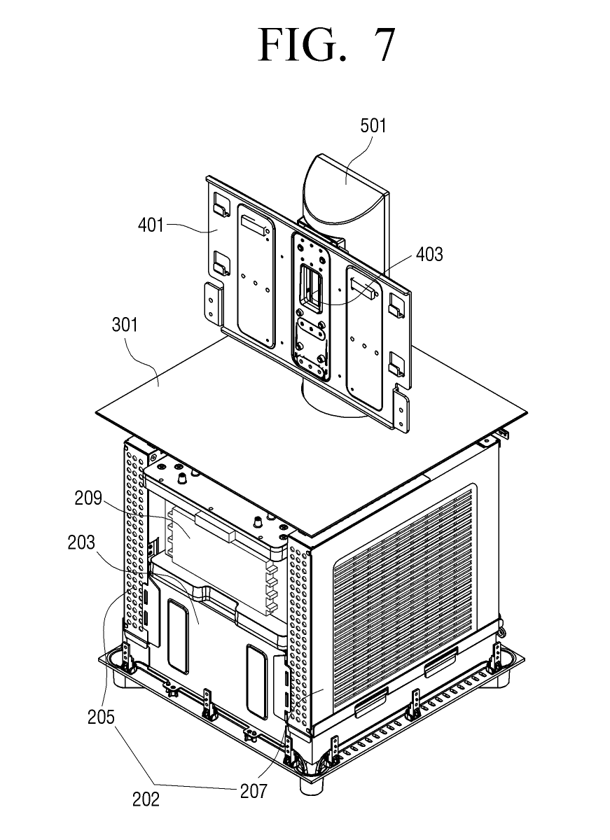

The drive body 201 may include a drive portion 209 (see, e.g., FIG. 2A and FIG. 7) that supports and rotates the main body 101. In order to stably support the main body having a specific weight, the drive body 201 may, for example, be formed to have a weight that is heavier than the weight of the main body 101. For example, various kinds of constituent elements of the display device 100, which have relatively large volume and heavy weight, may be arranged inside the drive body 201. For example, weight bodies, such as a power supply, a second speaker 203, the drive portion 209 (see FIG. 2A), and a metal frame (aluminum bar), may be arranged in the drive body 201.

The second speaker 203 may be a woofer speaker, have a weight that is relatively heavier than the weight of the first speakers 109 and 111, and process bass sound.

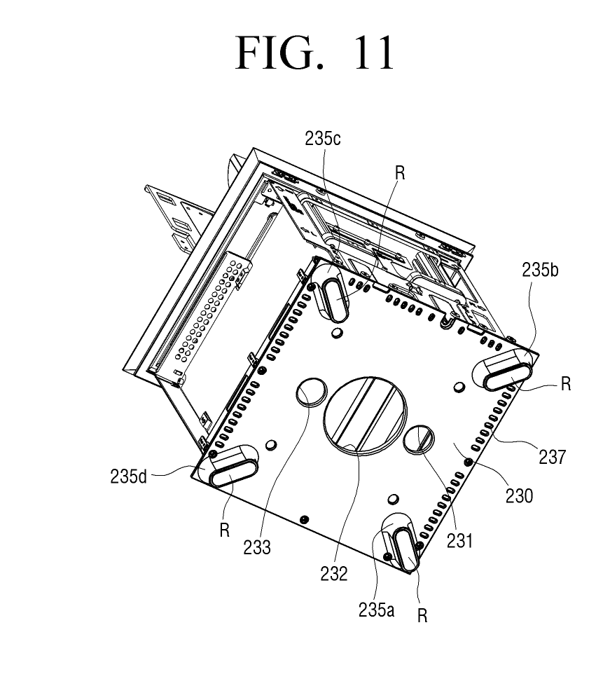

The drive body 201 may, for example, be roughly in a cubic shape. In consideration of the aesthetics of the drive body 201, it may be preferable not to form a heat dissipation hole 237 (see FIG. 11) for dissipating heat that is generated inside the drive body 201 and second speaker holes 231, 232, and 233 (see FIG. 11) for discharging sound that is output from the second speaker 203 on a side surface and an upper surface of the drive body 201 that can be observed by the user's naked eye. Accordingly, the heat dissipation hole 237 and the second speaker holes 231, 232, and 233 may, for example, be formed on a portion of the drive body 201 that may be difficult to observe by the user's naked eye, for example, on a lower surface of the drive body 201.

In the case where the second speaker holes 231, 232, and 233 are formed on the lower surface of the drive body 201 as described above, the bass sound that is processed by the second speaker that is a woofer speaker may be non-directional, and thus does not cause any inconvenience to a user even if the sound is discharged to the outside through the second speaker holes 231, 232, and 233 on the lower surface of the drive body 201.

The first speakers 109 and 111 may be arranged on the right side and the left side of the lower end portion of the main body 101 respectively, and the second speaker 203 may be arranged in the drive body 201. For example, in the display device, the left speaker 111 may, for example, have 20 W sound output, the right speaker 109 may have 20 W sound output, and the woofer speaker 203 may have 30 W sound output.

FIG. 2A is a front view of an example display device, and FIG. 2B is a block diagram of an example display device.

Referring to FIGS. 2A and 2B, the main body 101 and the drive body 201 are illustrated. The main body 101 may include a signal processor 1005 configured to process a signal that is generated from an outside or inside of the main body 101 of the display device 100 and to output audio and video signals, first speakers 109 and 111 configured to output the audio signal as sound, a display 1003 configured to output the video signal, and a controller 1001 configured to control an upper plate 301 of the drive body 201 to move upward and downward separated from the drive body 201 when the power of the main body 101 is turned on.

The signal processor 1005, the display 1003, and the controller 1001 may, for example, comprise separate circuit boards or at least one circuit board. For example, the signal processor 1005 may, for example, comprise a signal processing board. The display 1003 may, for example, comprise a display controller board and a display panel. The controller 1001 may, for example, comprise a controller board.

The drive body 201 may, for example, have a shape of a hexahedron, and may include the upper plate 301 that moves separated from the drive body 201 when, for example, an event occurs. The event may, for example, occur through power-on/off of the display device or a user input. A light emitting portion 303 may, for example, be mounted on the upper plate 301. The light emitting portion 303 may be configured to emit light when the upper plate 301 moves. Further, the light emitting portion 303 may be configured to emit light while the display device 100 is booted. Further, the light emitting portion 303 may be configured to emit light when the main body 101 is rotated. Further, the light emitting portion 303 may be configured to emit light in accordance with the audio output of the first speakers 109 and 111 and the second speaker 203. For example, the light emitting portion 303 may be turned on at predetermined time intervals when the audio is output, and the brightness of the emitted light may be adjusted corresponding to the strength of the audio output.

The second speaker 203 may be located at a lower end of the drive body 201. The second speaker 203 may have a vibration plate (not illustrated) that is directed toward the bottom and generates sound, and the sound may be discharged to the outside through the second speaker holes 231, 232, and 233 that are formed on a lower plate 230 (see, e.g., FIG. 11) of the drive body 201. The second speaker 203 may, for example, be a woofer speaker to process bass sound. For example, the second speaker 203 may process bass sound of 250 Hz or less.

The controller 1001 may be configured to control the light emitting portion 303 to emit light on the basis of the audio signal. Further, when the power of the main body 101 is turned on, the controller 1001 may be configured to send a signal to the drive body 201 and to control the drive portion 209 of the drive body 201 to move the upper plate 301 of the drive body 201 upward and downward. For example, the controller 1001 may be configured to control the drive portion 209 of the drive body 201 on the basis of an input to turn on the display device 100. For example, if a user turns on the power of the main body 101 using a remote controller, the controller 1001 may be configured to control the drive portion 209 of the drive body 201 to lift the upper plate 301 of the drive body 201 and may be configured to control the light emitting portion 303 to emit light. For example, the upper plate 301 may ascend for about 11 mm from the upper end of the drive body 201, and the light emitting portion 303 that is coupled to the upper plate 301 may emit light as the upper plate 301 ascends.

When the upper plate 301 and the main body 101 are coupled to each other, the main body 101 that is coupled to the upper plate 301 may ascend as the upper plate 301 ascends. The light emitting portion 303 that is coupled to the upper plate 301 may emit light while the main body 10 ascends.

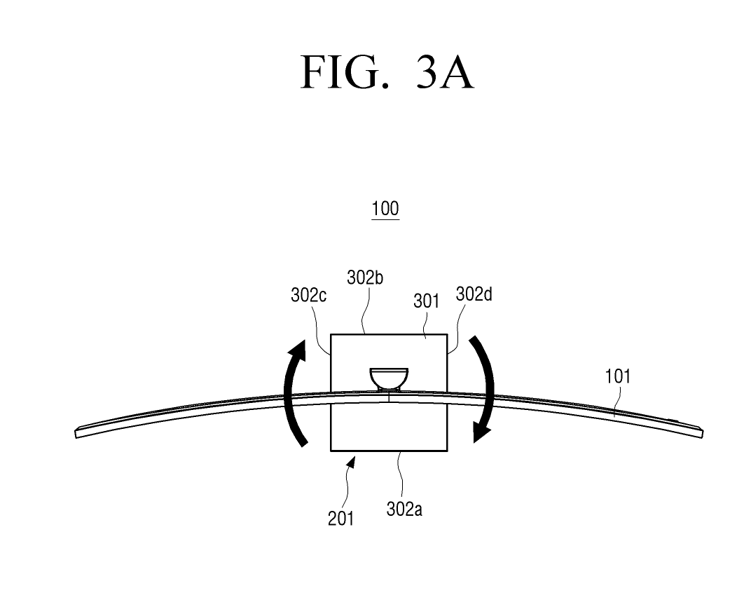

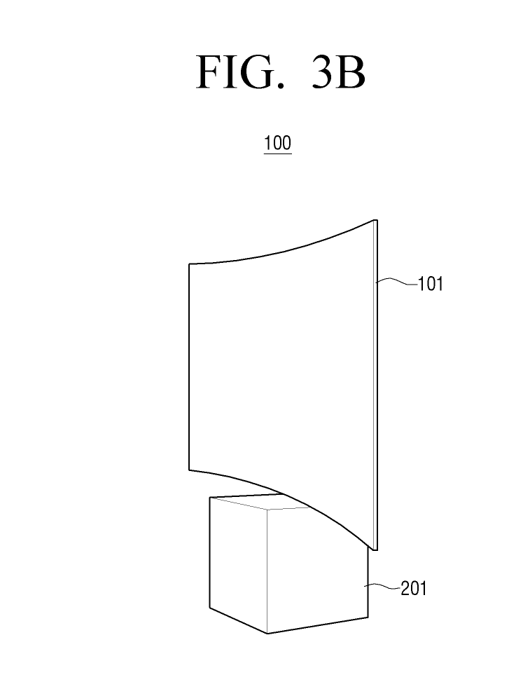

FIGS. 3A and 3B are views illustrating an upper surface and a side surface of an example display device.

Referring to FIG. 3A, the main body 101 may be rotated leftward and rightward within a predetermined rotation angle. For example, the rotation angle of the main body 101 may be roughly in the range of −6° to +6°. Since the main body 101 has a length (or left-right width) that is relatively longer than the length of the drive body 201, it may shake when it is rotated. For example, the main body 101 may move leftward and rightward when it is rotated. In order to prevent and/or reduce such shaking, the drive body 201 has an appropriate size and an appropriate weight. In order to secure an appropriate weight, the drive body 201 may, for example, include a separate weight body. For example, a metallic frame (aluminum bar) (not illustrated) may be mounted in the drive body 201 to secure a necessary weight.

Referring to FIG. 3B, the drive body 201 may, for example, be roughly in a cubic shape in order to stably support the main body 101. The drive body 101 has an appropriate height to prevent and/or reduce shaking when the main body 101 is rotated leftward and rightward. While in this example the horizontal cross section of the drive body 201 is in a rectangular shape, it will be understood that it is not limited thereto. The horizontal cross section of the drive body 201 may, for example, be in the shape of a polygon, such as a triangle or a pentagon, a circle, or an ellipse.

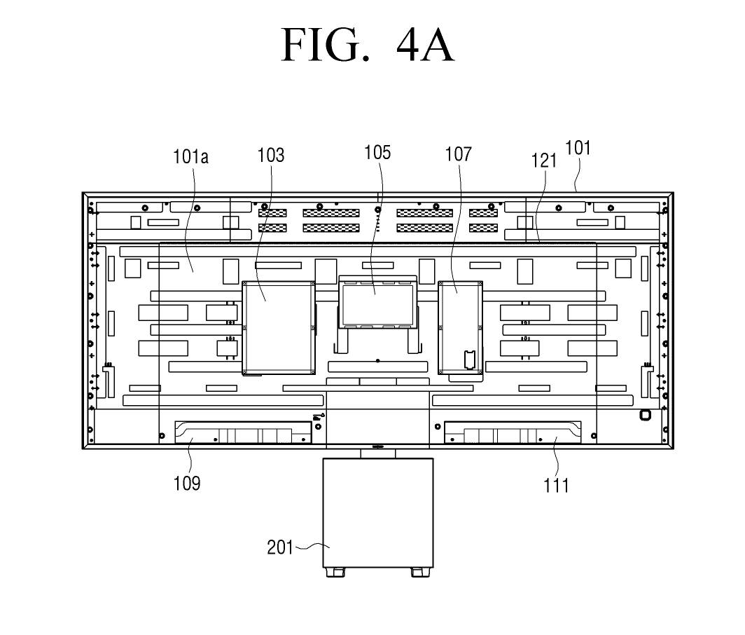

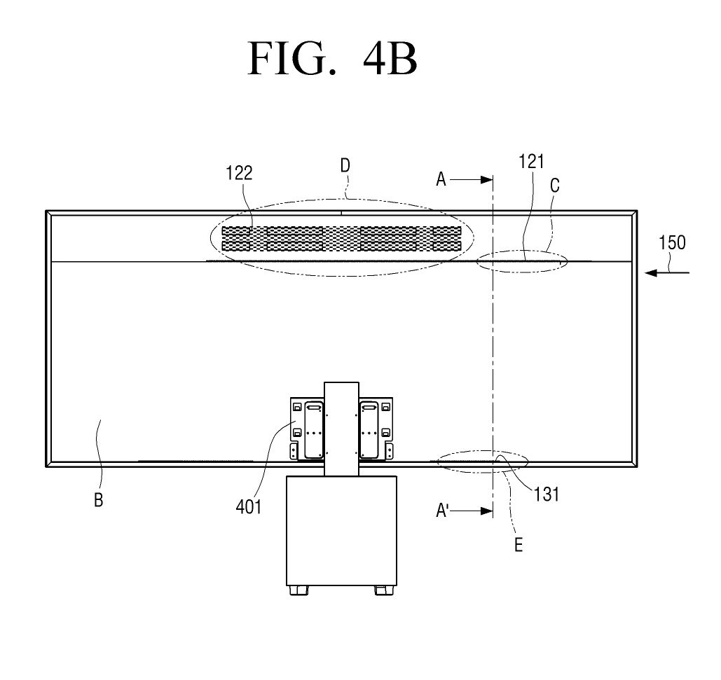

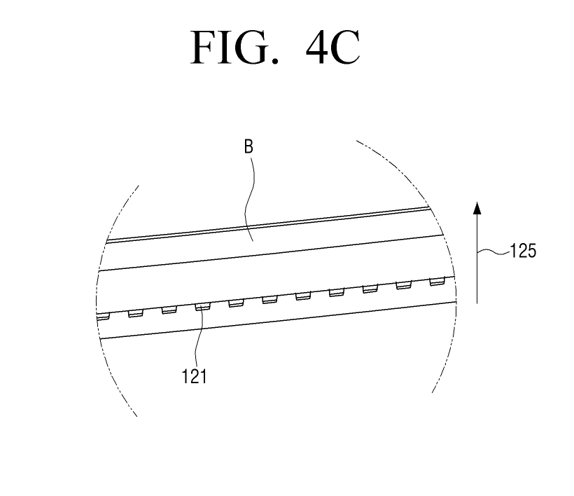

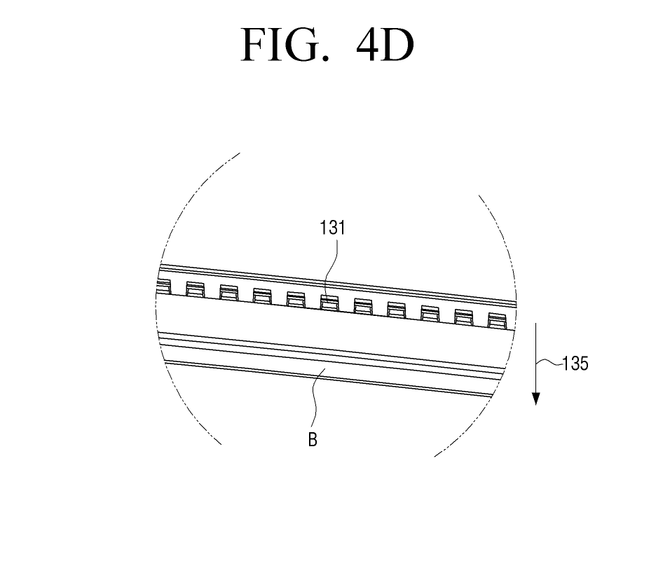

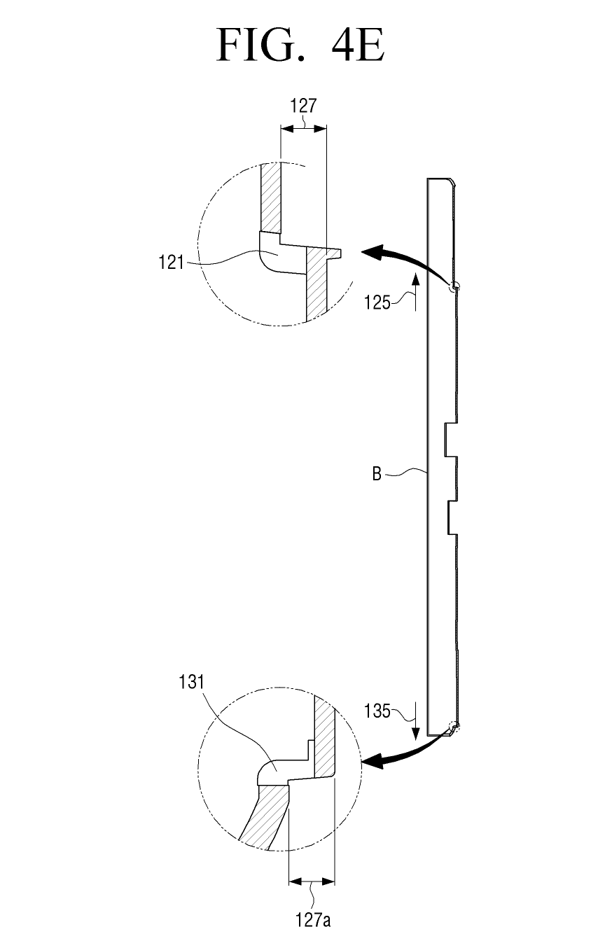

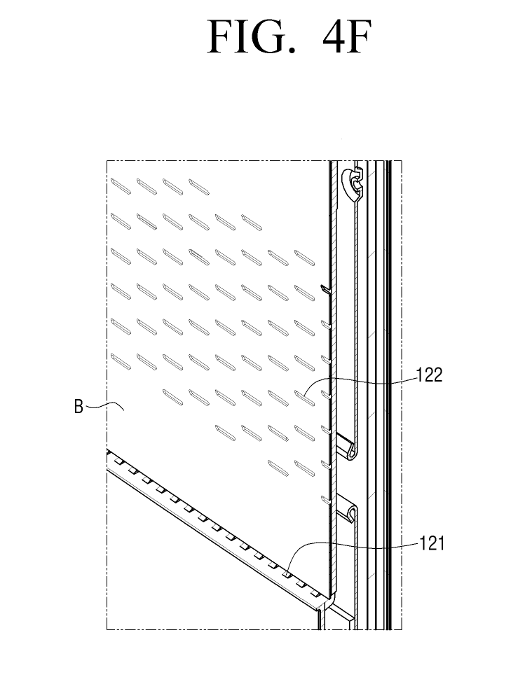

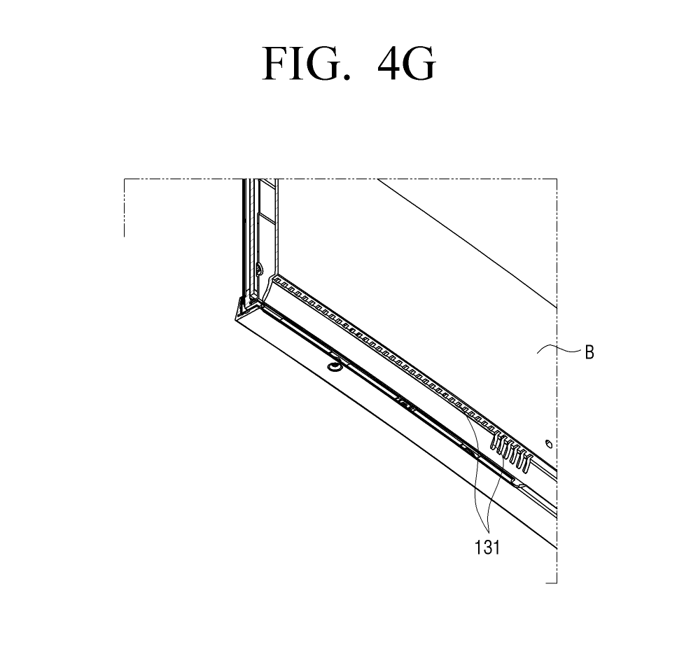

FIG. 4A is a view illustrating a front surface of an example display device in a state where a display panel is removed, and FIGS. 4B to 4G are views illustrating a rear surface of an example display device.

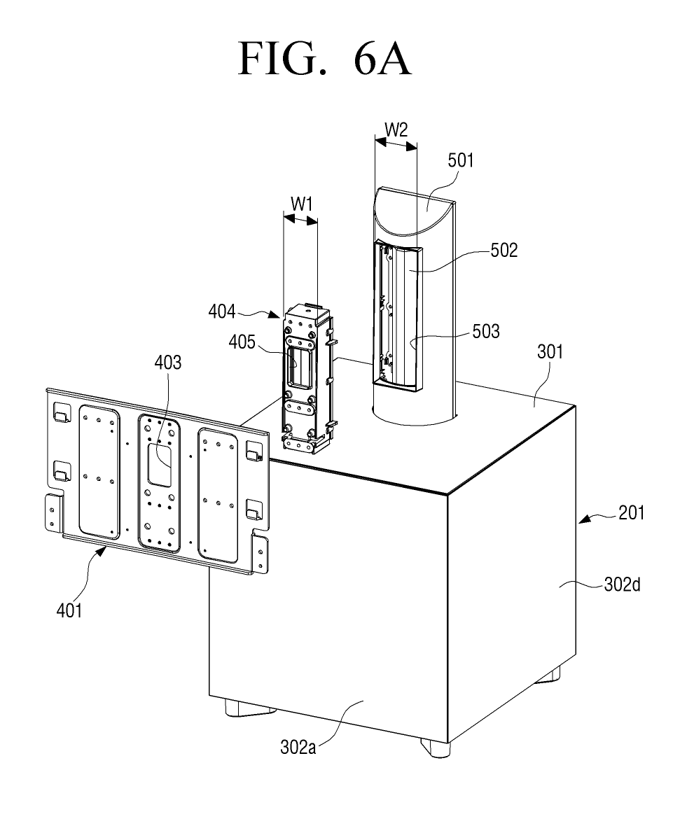

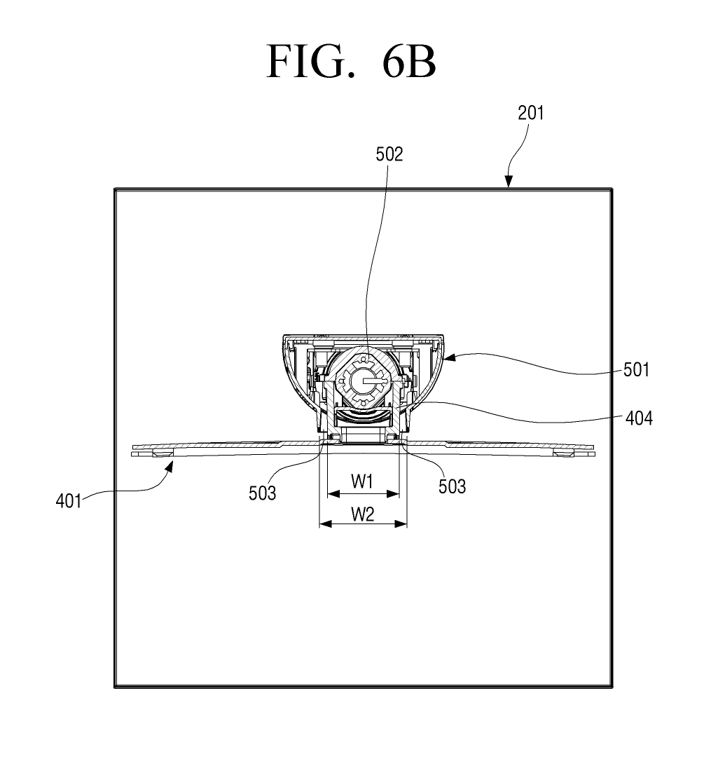

Referring to FIG. 4A, the main body 101 may include first to third circuit boards 103, 105, and 107, first speakers 109 and 111, a support member 401 (see, e.g., FIG. 4B), a shaft 502 (see, e.g., FIGS. 6A, 6B), and a cable 505. The first to third circuit boards 103, 105, and 107 may be mounted on a rear chassis 101a. The rear chassis 101a may, for example be made of a metal material, and may support the display panel 102.

Circuit board 103 may, for example, include the signal processor 1005. The signal processor may be configured to output audio and video signals. Second circuit board 105 may, for example, include the controller 1001. The controller 1001 may be configured to control the operation of the display device 100. Third circuit board 107 may, for example, be the display 1003. Further, the third circuit board 107 may control a backlight of the display panel 102. The first to third circuit boards 103, 105, and 107 may, for example, be arranged roughly in the center portion of the main body 101 (for example, in the center portion of the rear chassis 101a). Since the main body 101 has thin thickness and wide width, it may shake when it is being rotated leftward and rightward. The first to third circuit boards 103, 105, and 107 may, for example, be located in the center portion of the main body 101 to minimize and/or reduce the shaking of the main body 101.

The first speakers 109 and 111 may, for example, be located at a left lower end and at a right lower end. With respect to the front of the main body 101, the speaker located at the right lower end may be defined as the right speaker 109, and the speaker located at the left lower end may be defined as the left speaker 111. The left speaker 109 and the right speaker 111 may be symmetrically located with respect to the shaft 502 (or with respect to the center of the display panel 102).

The first speakers 109 and 111 may comprise magnets and metal materials, and may be relatively weighted constituent elements. For example, the first speakers 109 and 111 may be located at the lower end of the main body 101. Since the first speakers 109 and 111 are located at the lower end of the main body 101, the weight center of the main body 101 is positioned at the lower end of the main body 101. Accordingly, the shaking of the main body 101 can be minimized and/or reduced when the main body 101 is rotated leftward and rightward with respect to the drive body 201.

Referring to FIG. 4B, first to third holes 121, 122, and 131 are formed on a rear cover B of the main body 101. The first hole 121 is formed, for example, from the left end to the right end of an upper portion of the rear cover B roughly in a horizontal direction. The second hole 122 is formed, for example, roughly in the center of the upper portion of the rear cover B. The third hole 131 may be formed from the left end to the right end of a lower portion of the rear cover B roughly in the horizontal direction. The first to third holes 121, 122, and 131 serve as heat dissipation holes for dissipating heat that is generated inside the main body 101 to the outside of the main body. Further, the third hole 131 may also serve as a speaker hole for discharging sound that is output from the first speakers 109 and 111 to the outside of the main body.

FIGS. 4C and 4D are enlarged views of portions C and D illustrated in FIG. 4B, and FIG. 4E is a cross-sectional view taken along line A-A′ indicated in FIG. 4B.

Referring to FIG. 4C, the first hole 121 may comprise a plurality of holes 121. For example, the plurality of holes 121 may be directed in a vertically upward direction 125 due to a step portion 127 that is formed on the rear cover B as shown in FIG. 4E. Referring to FIG. 4D, the third hole 131 may comprise a plurality of holes 131. For example, the plurality of holes 131 may be directed in a vertically downward direction 135 due to a step portion 127a that is formed on the rear cover B as shown in FIG. 4E. As described above, the first and third holes 121 and 131 may be in different directions opposite to each other.

FIG. 4F is an enlarged cross-sectional view illustrating the example main body 101 illustrated in FIG. 4B cut roughly in a vertical direction.

Referring to FIG. 4F, the first hole 121 and the second hole 122 may be formed in different directions on the rear cover B. For example, the direction of the first hole 121 may be roughly orthogonal to the direction of the second hole 122.

FIG. 4G is an enlarged view of portion E illustrated in FIG. 4B. Referring to FIG. 4G, the third hole 131 is formed in a position that includes a portion in which the first speakers 109 and 111 are arranged, for example, on the lower portion of the rear cover B. Accordingly, the third hole 131 can discharge the sound output from the first speakers 109 and 111 to the outside of the main body 101.

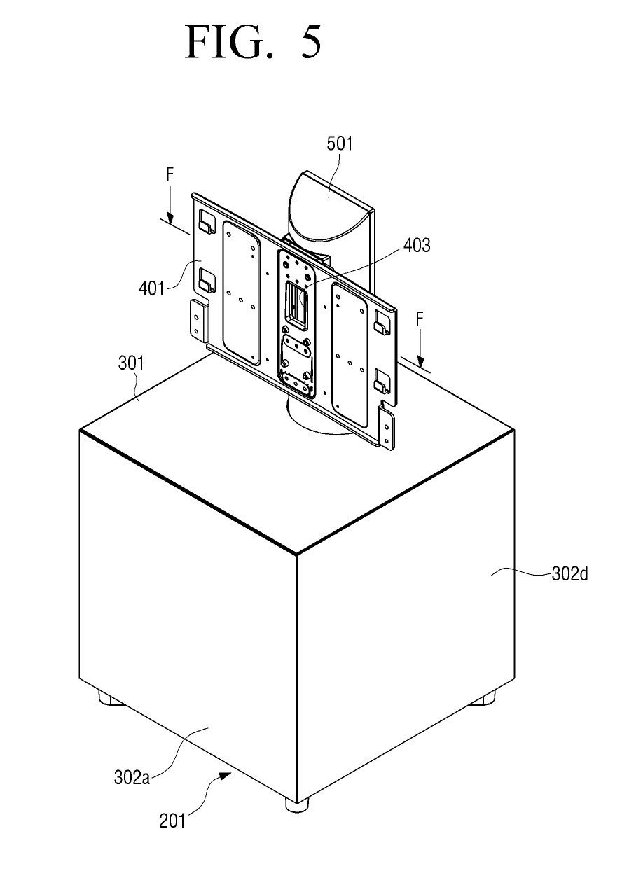

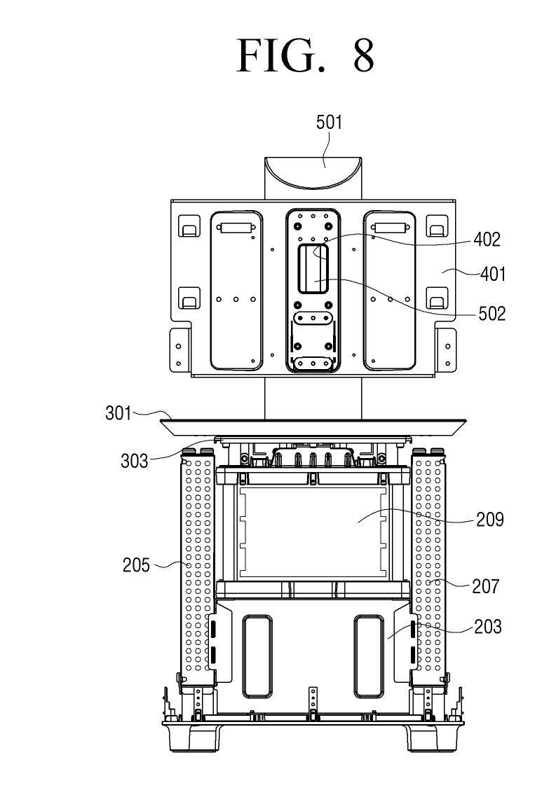

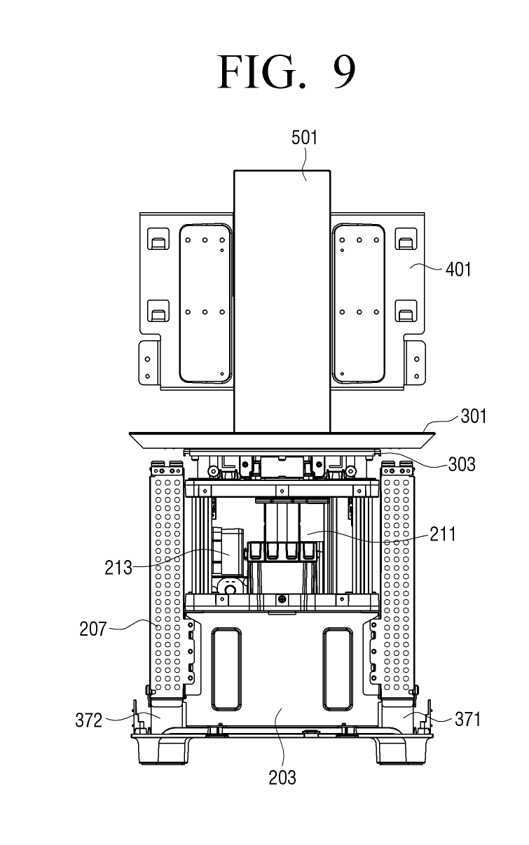

FIG. 5 is a view illustrating an example drive body 201 that supports an example main body 101 of a display device 100, FIG. 6A is an exploded perspective view illustrating an example connection structure between a support member and a shaft, and FIG. 6B is a cross-sectional view taken along line F-F illustrated in FIG. 5. FIG. 7 is a view illustrating an inside of an example drive body, FIG. 8 is a view illustrating an inside of an example drive body as seen from the front, and FIG. 9 is a view illustrating an inside of an example drive body as seen from the rear.

Referring to FIGS. 5 to 9, the drive body 201 includes a power portion 202, a second speaker 203, a first power board 205, a second power board 207, an upper plate 301, a front plate 302a, a rear plate 302b, a left plate 302c, a right plate 302d, a drive portion 209, a light emitting portion 303, weight bodies 371 and 372, a support member 401, and a shaft cover 501.

Referring to FIG. 7, the power portion 202 and the second speaker 203 are arranged inside the drive body 201.

The power portion 202 may supply a power to respective electronic components of the display device 100. The power portion 202 may supply the power to the main body 101 and the drive body 201. The power portion 202 may supply the power to the main body 101 through a cable that is arranged inside the shaft cover 501.

The power portion 202 may include the first power board 205 and the second power board 207. The first power board 205 and the second power board 207 may be positioned on left and right sides of the second speaker 203, respectively.

The first power board 205 may be arranged in parallel to the left plate 302c or the right plate 302d of the drive body 201. The second power board 207 may be arranged in parallel to the left plate 302c or the right plate 302d of the drive body 201. The second speaker 203 may be a woofer speaker which is a bass speaker that processes sound of, for example, roughly 250 Hz or less. Since bass sound has a long wavelength and requires a large amount of energy, the woofer speaker, which has a large size and no directivity, may be arranged on a lower end portion of the drive body 201. Further, since the woofer speaker has a heavy weight, it may also serve as a weight body of the drive body 201. The wavelength of the bass sound that is generated from the woofer speaker may enable heat that is generated from the first power board 205 and the second power board 207, which are positioned on the left and right sides of the woofer speaker, to be easily dissipated to the outside.

Referring to FIGS. 3A and 5, the drive body 201 may include the upper plate 301, the front plate 302a, the rear plate 302b, the left plate 302c, and the right plate 302d.

The upper plate 301 may form the upper portion of the drive body 201, and may move upward and downward separated from upper ends of the front plate 302a, the rear plate 302b, the left plate 302c, and the right plate 302d of the drive body 201 (see FIG. 3A). When the power of the main body 101 is turned on, the upper plate 301 may ascend to a predetermined height.

In consideration of the aesthetics of the drive body 201, any separate hole (e.g., hole for a fastening screw) may, for example, not be formed on the front plate 302a, the left plate 302c, and the right plate 302d. For example, it may be preferable to fasten the front plate 302a, the left plate 302c, and the right plate 302d to one another through fastening screws from the inside of the respective plates 302a, 302c, and 302d. The rear plate 302b may be coupled to the drive body 201 through a permanent magnet. For this, the rear plate 302b may be fixed to the left plate 302c and the right plate 302d using the permanent magnet. On the rear plate 302b, a hole (not illustrated) may be formed, through which an AC power cable (not illustrated) passes.

Referring to FIG. 5, the support member 401 may be made of a metal material, and may be fixedly fastened to the rear chassis 101a (see FIG. 4A) of the main body 101 through fastening screws (not illustrated). The rear chassis 101a is covered by the rear cover B, and thus is not exposed to the outside of the main body 101. Further, on the support member 401, a hole 403 may be formed, through which power and signal cables (not illustrated) pass.

Referring to FIGS. 6A and 6B, the support member 401 may be fixedly coupled to the shaft 502 through a connection member 404. On the connection member 404, a hole 405 may be formed to correspond to the hole 403 of the support member 401.

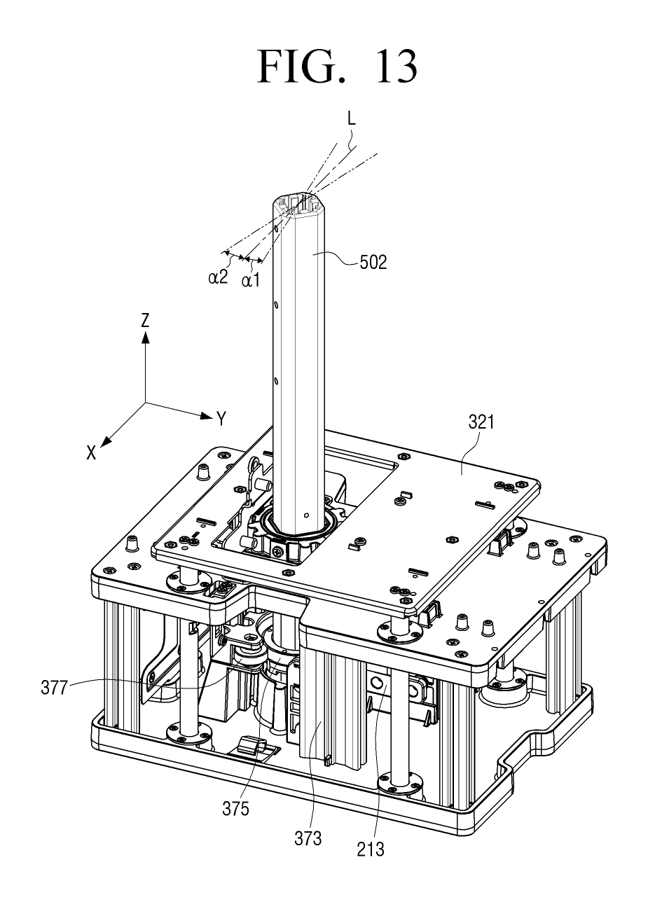

The shaft cover 501 may, for example, be in a semicircular cylinder shape. The shaft cover 501 may penetrate the upper plate 301 and may guide upward and downward movement of the upper plate 301. The shaft 502 (see FIG. 13) is arranged inside the shaft cover 501, and a through-hole 503, to which the connection member 404 is coupled, is formed on the front portion of the shaft cover 501.

In this case, the width W2 of the through-hole 503 is set to be wider than the width W1 of the connection member 404. This is to prevent the connection member 404 from being interfered with both end portions of the through-hole 503 of the shaft cover 501 when the shaft 502 is rotated leftward and rightward (see FIG. 13). In relation to this, referring to FIG. 6B, when the connection member 404 is coupled to the shaft 501, a gap having a predetermined length is formed between the both end portions of the connection member 404 and the both end portions of the through-hole 503. Accordingly, the shaft 502 may be rotated leftward and rightward in the range of predetermined angles α1 and α2 inside the shaft cover 501 (see FIG. 13), and may rotate the main body 101 leftward and rightward through the connection member 404 and the support member 401. Further, on the shaft cover 501, a power cable, an audio signal cable, and a data cable (not illustrated) may be arranged.

Referring to FIGS. 7 and 8, the light emitting portion 303 may be coupled to the upper plate 301. For example, the light emitting portion 303 may emit light in association with the ascending/descending operation of the upper plate 301. The drive portion 209 may be arranged below the upper plate 301, and the second speaker 203 may be arranged below the drive portion 209. The first power board 205 and the second power board 207 may be arranged on both side surfaces of the drive portion 209. Further, the first power board 205 and the second power board 207 may be arranged even on both side surfaces of the second speaker 203.

Referring to FIG. 9, the drive portion 209 may include a first actuator 211 and a second actuator 213. The first actuator 211 and the second actuator 213 may, for example, be forward-reverse rotating motors. The first actuator 211 may provide a motive power for moving the upper plate 301 of the drive body 201 upward and downward, and the second actuator 213 may provide a motive power for rotating the main body 101 leftward and rightward.

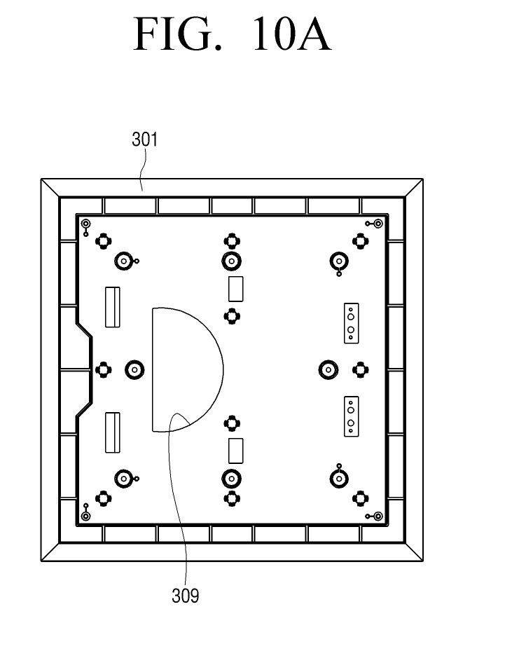

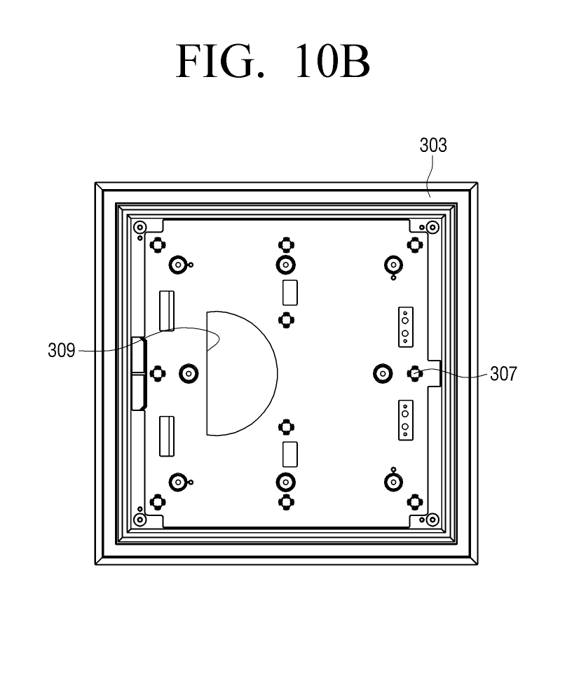

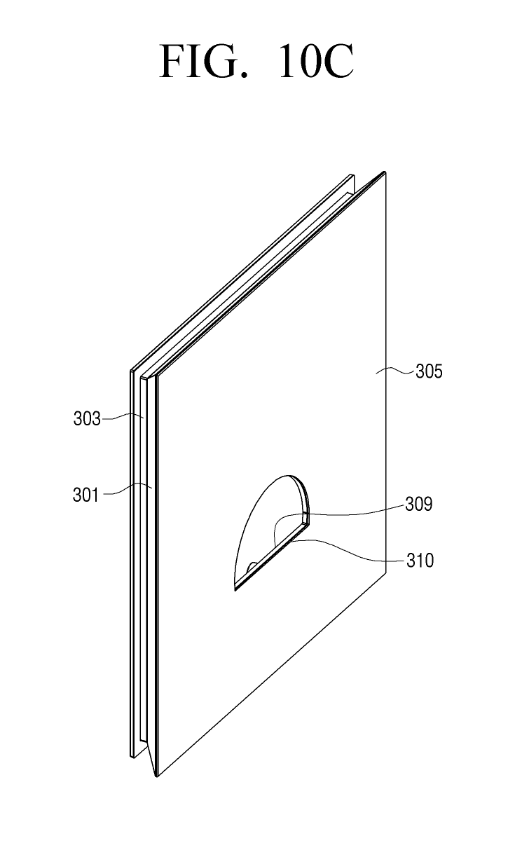

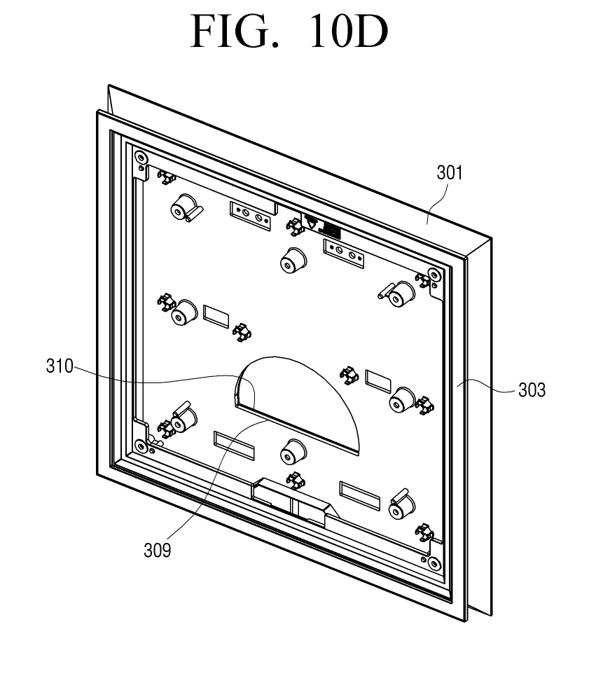

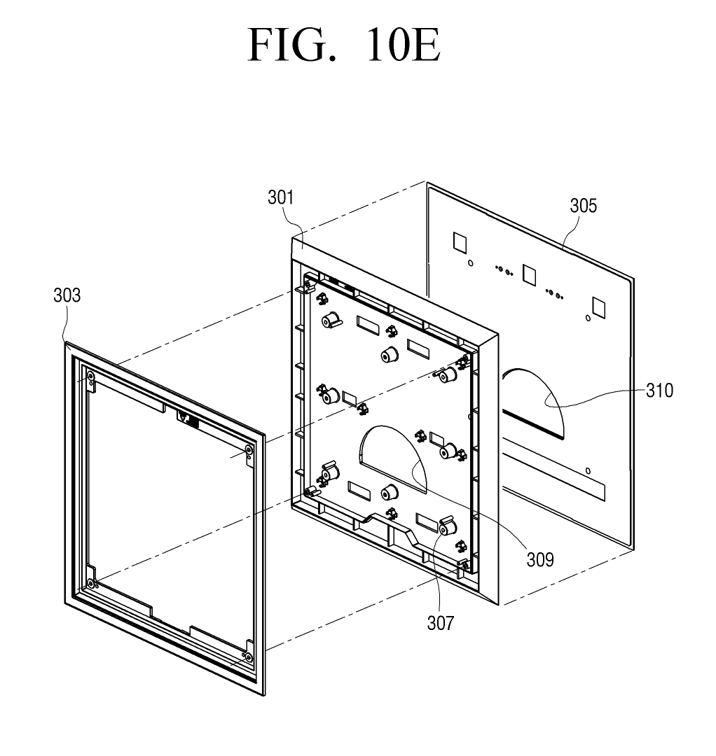

FIG. 10A is a view illustrating an upper surface of an example upper plate, and FIG. 10B is a view illustrating a lower surface of an example upper plate and an example light emitting portion. FIG. 10C is a perspective view of an example upper plate and an example light emitting portion as seen from the side, and FIG. 10D is a perspective view of an example upper plate and an example light emitting portion as seen from the lower side. FIG. 10E is an exploded perspective view of an example upper plate and an example light emitting portion.

Referring to FIG. 10A, an upper plate cover 305 (see FIG. 10C) may be coupled to an upper surface of the upper plate 301. A permanent magnet 307 may be mounted on a rear surface of the upper plate 301, and the upper plate cover may be fastened to the upper surface of the upper plate 301 using the permanent magnet 307 (see FIG. 10B).

Referring to FIG. 10B, the light emitting portion 303, the permanent magnet 307, and a hole 309 are arranged on the rear surface of the upper plate 301.

The light emitting portion 303 may include a light guide panel and a light emitting source (not illustrated). Light that is emitted from the light emitting source may be uniformly spread through the light guide panel. LED may be used as the light emitting source. Further, a small lamp or a fluorescent lamp may be used as the light emitting source.

The permanent magnet 307 may couple the upper plate cover of the upper plate 301 to the upper plate. Since the upper plate cover of the upper plate 301 is fastened to the upper plate by the permanent magnet 307, a separate fastening screw is not required.

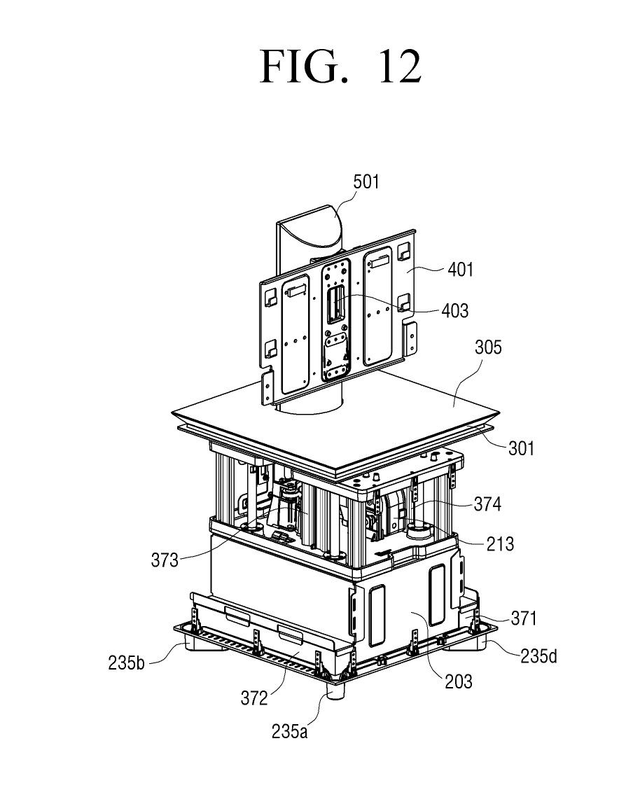

Referring to FIG. 10C, the through-hole 309 that the shaft 502 can penetrate (see FIG. 12) is formed on the upper plate 301. Further, another through-hole 310 having the same size as the size of the through-hole 309 is also formed on the upper plate cover 305. The shaft 502 may guide the upper plate 301, and the upper plate 301 may move along the shaft 502.

Referring to FIG. 10D, the light emitting portion 303 may be fastened to the upper plate 301 by fastening screws, and the light emitting source may be positioned between the light emitting portion 303 and the upper plate 301.

Referring to FIG. 10E, the light emitting portion 303 may be fastened to the upper plate 301 through fastening screws. Further, the upper plate cover 305 may be fastened to the upper surface of the upper plate 301 through the permanent magnet 307. As described above, since the upper plate 301 is coupled to the upper plate cover 305 using the permanent magnet 307 without using separate fastening screws, fastening screw holes are not formed on the upper plate cover 305.

FIG. 11 is a view illustrating a lower plate and a main portion of an example drive body.

Referring to FIG. 11, the lower plate 230 of the drive body 201 may include second speaker holes 231, 232, and 233, a heat dissipation hole 237, and legs 235a, 235b, 235c, and 235d. Sound that is generated from the second speaker 203 through the second speaker holes 231, 232, and 233 may be discharged to the outside of the drive body 201. The second speaker 203 may be a bass speaker. Since the bass sound has no directivity, the sound may be discharged to the outside through the holes formed on the lower plate 230. Further, in consideration of the design of the drive body 201, any separate heat dissipation hole and sound discharge hole are not formed on the side surface of the drive body 201.

On the lower plate 230 of the drive body 201, the four legs 235a, 235b, 235c, and 235d may be formed. The four legs 235a, 235b, 235c, and 235d may be integrally formed on projection portions of the lower plate 230, or may be coupled to the lower plate 230 using separate members. Skid-proof rubber R may be mounted on each of the four legs 235a, 235b, 235c, and 235d to stably fix the drive body 201 to a bottom surface without skidding. The four legs 235a, 235b, 235c, and 235d may form a space with a predetermined height between the lower plate 230 and the bottom surface. The sound that is discharged from the second speaker 203 and the heat that is generated from the inside of the drive body 201 may be discharged to the outside of the drive body 201 through the space between the lower plate 230 and the bottom surface.

FIG. 12 is a view illustrating the inside of an example drive body.

Referring to FIG. 12, the main body 101 of the display device 100 is coupled to the support member 401, and the support member 401 may be fastened to the shaft 502 (see FIG. 13) that is inside the shaft cover 501 using fastening screws (not illustrated).

In the shaft cover 501, a cable (not illustrated) for supplying the power from the drive body 201 to the main body 101 and a cable (not illustrated) for transmitting a signal from the main body 101 to the drive body 201 may be located. These cables may be connected to the main body 101 through the hole 403 formed on the support member 401.

The weight bodies 371 and 372 may be aluminum bars, and increase the weight of the drive body 201 so that the drive body 201 can stably support the main body 101. The weight bodies 371 and 372 may be arranged at the lower end of the drive body 201. The weight bodies 371 and 372 may be arranged on the left and right sides of the second speaker 203. The weight of the weight bodies 371 and 372 may be determined based on the size and the weight of the main body 101. For example, the weight bodies 371 and 372 become heavier as the size and the weight of the main body 101 become greater.

Since the main body 101 has the size that is relatively larger than the size of the drive body 201, the width of the main body 101 is set to be larger than the width of the drive body 201, and thus the shaft 502 may be tilted or the position of the shaft 502 may be changed due to the weight of the main body 101. Reinforcement members 373 and 374 may prevent and/or reduce deformation of the shaft 501. The reinforcement members 373 and 374 may be arranged around the shaft 502. The reinforcement members 373 and 374 may be made of a metal material having a predetermined stiffness.

FIG. 13 is a view illustrating in detail surroundings of a shaft 502 of an example drive body.

Referring to FIG. 13, the shaft 502 may be made of a metal material, and may be rotated about a rotating shaft. For example, the shaft 502 may be rotated within the range of a first angle α1 (e.g., +6°) to a second angle α2 (e.g., −6°) from a reference line L that is in parallel to the X-axis.

A lifter 321 may be coupled to the upper plate 301. Accordingly, as the lifter 321 ascends and descends, the upper plate 301 also ascends and descends.

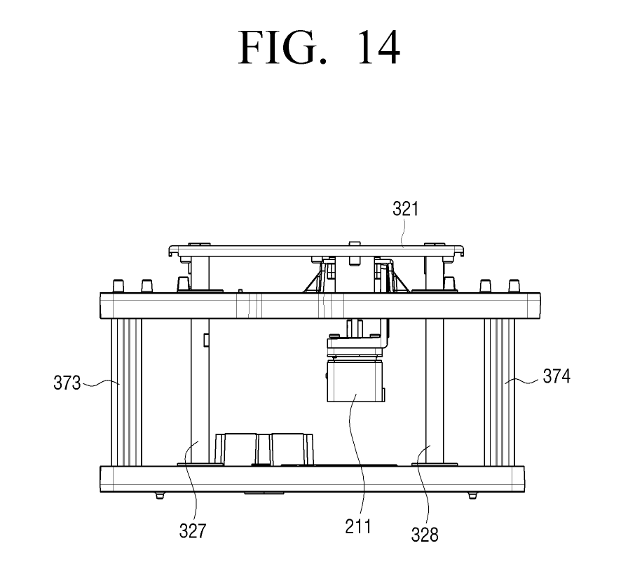

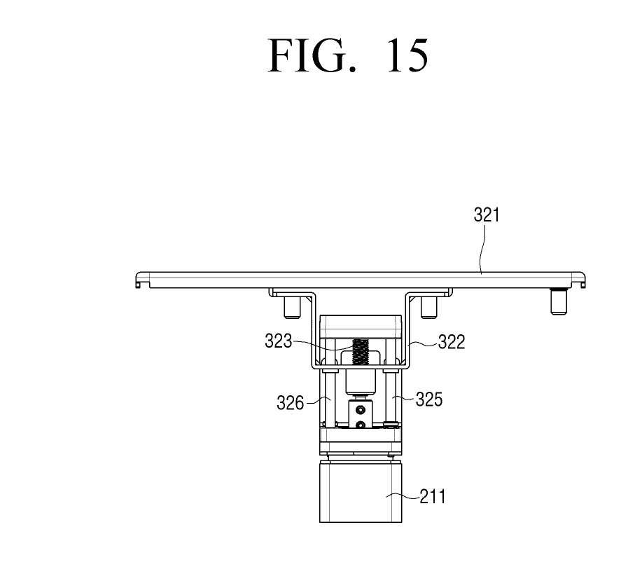

FIG. 14 is a view illustrating side surfaces of a lifter 321 and a first actuator 211, and FIG. 15 is a detailed view of an example connection structure between a lifter 321 and a first actuator 211. Referring to FIG. 14, the first actuator 211 may be forward/reverse rotating motors. Further, the first actuator 211 may a solenoid. As the first actuator 211 is driven, the lifter 321 may ascend or descend. Lifter stands 327 and 328 support the lifter 321. Four lifter stands 327 and 328 may be provided, and when the lifter 321 moves, the lifter stands may guide the lifter 321 to ascend/descend without being shaken leftward and rightward.

Referring to FIG. 15, the first actuator 211 may be a motor, and in this case, screw threads 323 may be formed on a rotation shaft of the first actuator 211. The upper side of a stand 322 may be coupled to the bottom surface of the lifter 321, and a female screw portion (not illustrated) that is screw-engaged with the screw thread 323 may be formed on the lower side of the stand 322. For example, the female screw portion may be made of a separate member, and may be coupled to the stand 322.

Four guide bars 325 and 326 may be provided to penetrate holes (not illustrated) formed on the stand 322, and thus can guide the stand 322 when the stand 322 moves upward and downward.

As the rotating shaft of the first actuator 211 is rotated, the stand 322 that is screw-engaged with the rotating shaft through the female screw portion may ascend or descend based on the rotation direction of the rotation shaft. Accordingly, the lifter 321 and the upper plate 301 connected to the lifter 321 may ascend or descend together with the stand 322.

A pair of guide bars 325 and 326 pass through the four holes formed on the stand 322. The stand 322 may uniformly ascend or descend along the guide bars 325 and 326 without being tilted.

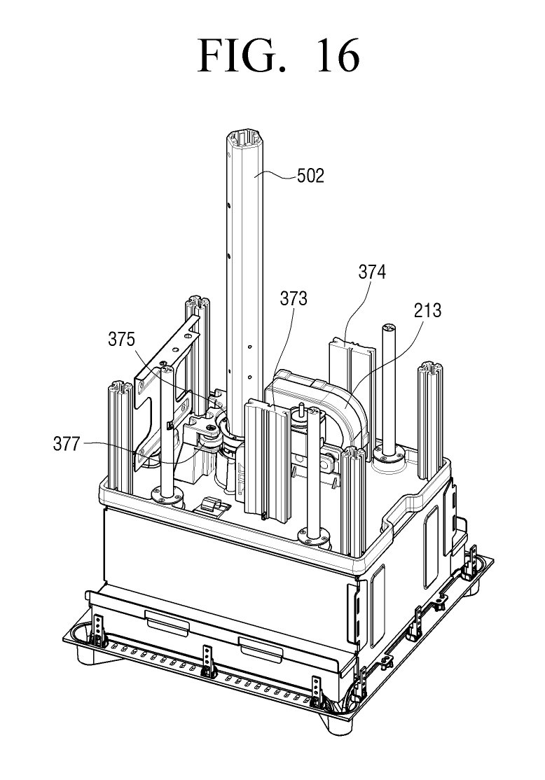

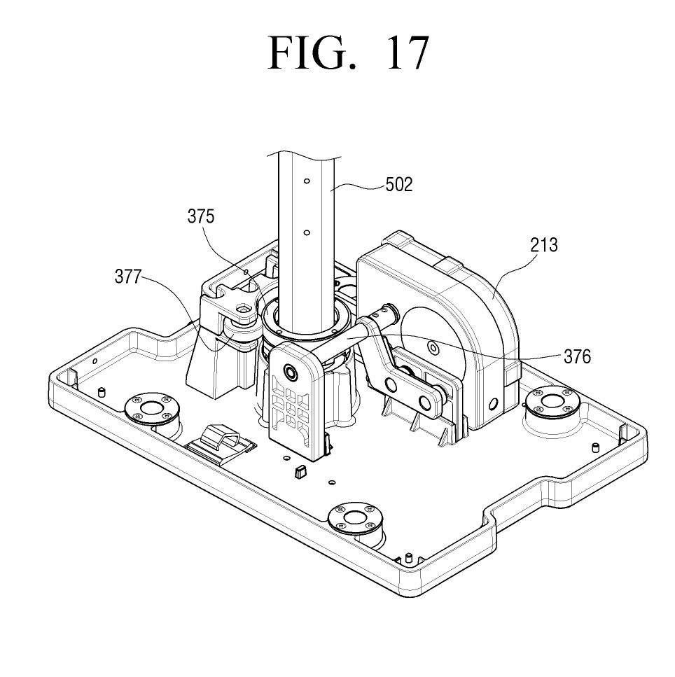

FIG. 16 is a perspective view illustrating an example structure for driving a shaft 502, and FIG. 17 is an enlarged view of surroundings of an example worm gear 375.

Referring to FIG. 16, the reinforcement members 373 and 374 may be arranged on the left and right sides of the second actuator 213, and may serve to support the shaft 502. The shaft 502 may be made of a metal material. The worm gear 375 may be coupled to the lower end portion of the shaft 502.

Referring to FIG. 17, a worm 376 may be formed on or may be coupled to the second actuator 213. Since the worm 376 is gear-connected to the worm gear 375, it is rotated when the second actuator 213 is driven to rotate the worm gear 375. One side of the worm gear 375 may be connected to a dummy gear 377. Two dummy gears 377 may be provided. Since the worm gear 375 is connected to the two dummy gears 377 and the worm 376, the shaft 502 that is connected to the worm gear 375 can be stably rotate without moving leftward and rightward.

Further, as described above, by the reinforcement members 373 and 374 that are arranged on the left and right sides of the second actuator 213, the shaft 502 can firmly support and rotate the main body 101.

The rotation force that is generated from the second actuator 213 may be transferred to the worm gear 375 through the worm 376, and as the worm gear 375 is rotated, the shaft 502 can be rotated leftward or rightward within a predetermined angle range. The worm gear 375 is gear-connected to the worm 376 and is also gear-connected to the pair of dummy gears 377.

The pair of dummy gears 377 are rotated together as the worm hear 375 is rotated, but the rotation force of the dummy gears 377 is not transferred to another gear or member. Further, the dummy gears 377 support the worm gear 375 to prevent and/or reduce the position of the shaft 502 from being upset. The second actuator may be a forward/reverse rotating motor or a solenoid.

One of the reinforcement members 373 and 374 may be arranged around the worm gear 375 and the shaft 502 to support the shaft 502 so that the position of the shaft 502 is not upset.

Referring to FIG. 2B controller 1001 may be configured to control the whole display device. In the case where the power is turned on through control of the drive portion 209 of the drive body 201, the controller 1001 is configured to make the main body 101 ascend and to make the light emitting portion 303 emit light. The controller 1001 may be configured to transmit first data for controlling the drive portion 209 and second data for controlling the light emitting portion 303 to the drive portion 209 of the drive body 201 and the light emitting portion 303 through cables arranged inside the shaft 502.

When the power is turned on, the controller 1001 may be configured to drive the light emitting portion 303 to emit light, and the light emitting portion 303 may continue to emit light while booting of the main body 101 is performed. For example, if the booting is completed, the controller 1001 may be configured to control the light emitting portion 303 to stop the light emitting operation. Further, even if the booting is completed, the controller 1001 may be configured to control the light emitting portion to emit light continuously.

The controller 1001 may be configured to operate the second actuator 213 based on an input for rotating the main body 101.

The display 1003 may include a display panel, a display controller, and a backlight. The display 1003 receives a video signal and is configured to display a screen on the display panel 102.

The signal processor 1005 is configured to output an audio signal and a video signal. The audio signal is output to the first speakers 109 and 111 and the second speaker 203, and the first speakers 109 and 111 and the second speaker 203 generate sound. The second speaker 203 may process bass sound in comparison to the first speakers 109 and 111, and may be positioned in the drive body 201. The second speaker 203 has a weight that is heavier than the weight of the first speakers 109 and 111.

The signal processor 1005 is configured to output the audio signal, and a part of the audio signal may be output to the second speaker 203. A cable for supplying the audio signal to the second speaker 203 may be located inside the shaft cover 501.

In the example display device 100, the controller 1001, the signal processor 1005, and the first speakers 109 and 111, which have relatively light weights, may be located in the main body 101, and the drive portion 209, the power portion 202, and the second speaker 203, which have relatively heavy weights, may be arranged in the drive body.

Through this, the main body 101 may be maintained slim and light in comparison to the drive body 201, and the drive body 201 may secure sufficient weight to stably support the main body 101.

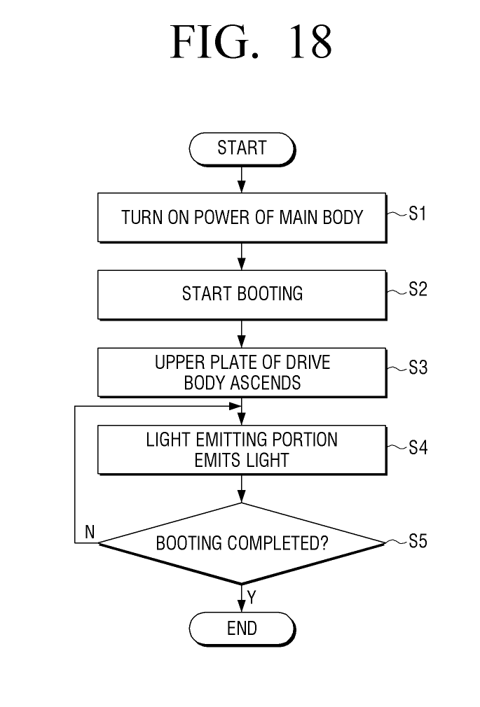

FIG. 18 is a flowchart illustrating an example process in which an upper plate ascends in an example display device.

If the power of the main body is turned on (S1), the display device starts booting (S2). The power of the main body 101 may be turned on by a user. The user may turn on the power of the main body 101 through operation of a remote controller (not illustrated) or a power button (not illustrated) provided on the main body 101.

The controller 1001 is configured to turn on the power of the main body 101 on the basis of the user input for turning on the power of the main body 101 (S1) and then starts booting (S2). For example, the user may turn on the power of the main body 101 through operation of a remote controller (not illustrated) or a power button (not illustrated) provided on the main body 101.

The controller 1001 is configured to transmit first data to the drive portion 209 included in the drive body 201. If the first data is received, the drive portion 209 drives the first actuator 211 to make the upper plate 301 of the drive body 201 ascend (S3).

Further, the controller 1001 may be configured to transmit second data to the light emitting portion 303. The light emitting portion 303 receives the second data and emits light (S4).

The controller 1001 is configured to determine whether the booting is completed (S5). If the booting is completed, the controller 1001 is configured to end the booting, whereas if the booting is not completed, the controller 1001 may be configured to control the light emitting portion 303 to emit light continuously. For example, the controller 1001 may be configured to transmit the first data and the second data simultaneously or successively.

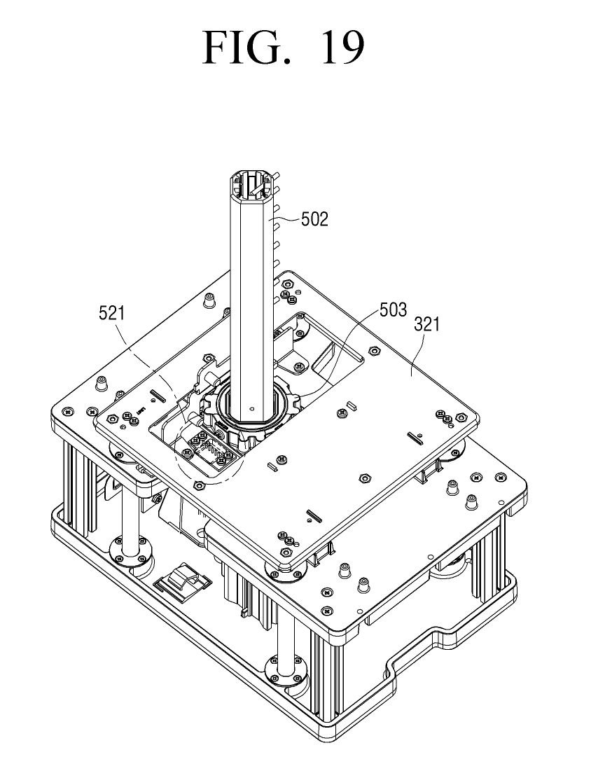

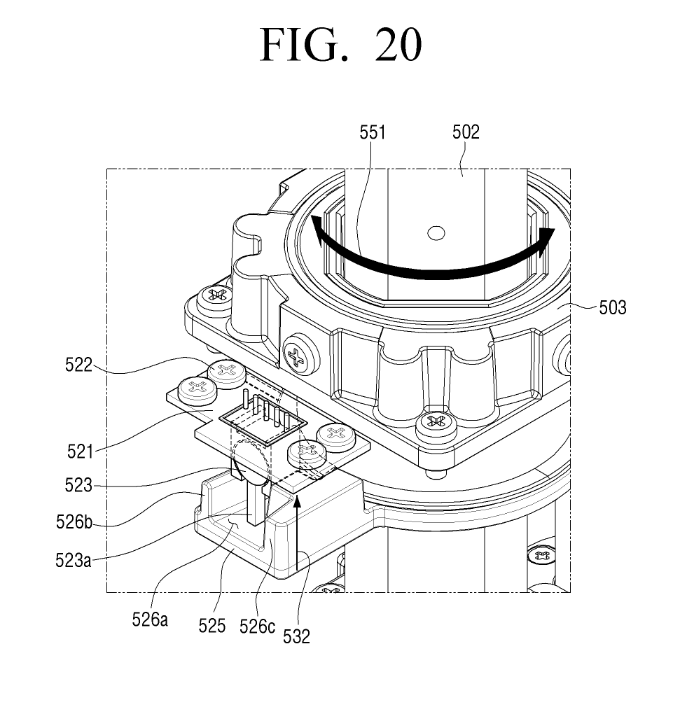

FIG. 19 is a view illustrating a shaft 502 and a switch board 521 arranged around the shaft 502, and FIG. 20 is an enlarged view illustrating surroundings of a switch board 521.

Referring to FIGS. 19 and 20, the shaft 502 may be rotated in leftward and rightward directions 551 about the shaft. A limit switch 523 may be mounted to prevent the shaft 502 from being endlessly rotated.

A shaft cap 503 supports the shaft 502, and the position of the shaft cap is not changed according to the rotation of the shaft 502, but is fixed. To one side of the shaft cap 503, the switch board 521 may be fastened and coupled through screws 522. The switch board 521 may include the limit switch 523 and a proximity sensor (not illustrated).

A knob 523a may be coupled to the limit switch 523. The knob 523a may be pivoted leftward or rightward by an external force about the shaft. As the knob 523a is pivoted leftward or rightward, the limit switch 523 operates to stop the rotation of the shaft 502.

A groove 526a may be formed on the step portion 525, and the knob 523a of the limit switch 523 may be inserted into the groove 526a. Walls 526b and 526c may be formed on the left and right sides of the groove 526a. The step portion 525 is rotated as the shaft 502 is rotated, and as the step portion 525 is rotated, the walls 526b and 526c on the left and right sides of the step portion 525 come in contact with the knob 523a to pivot the knob 523a leftward or rightward.

As the shaft 502 is rotated, the shaft cap 503 and the switch board 521 are rotated. The knob 523a may be pivoted leftward or rightward by the walls 526b and 526c on the left and right sides formed on the step portion 525 to stop the rotation of the shaft 502.

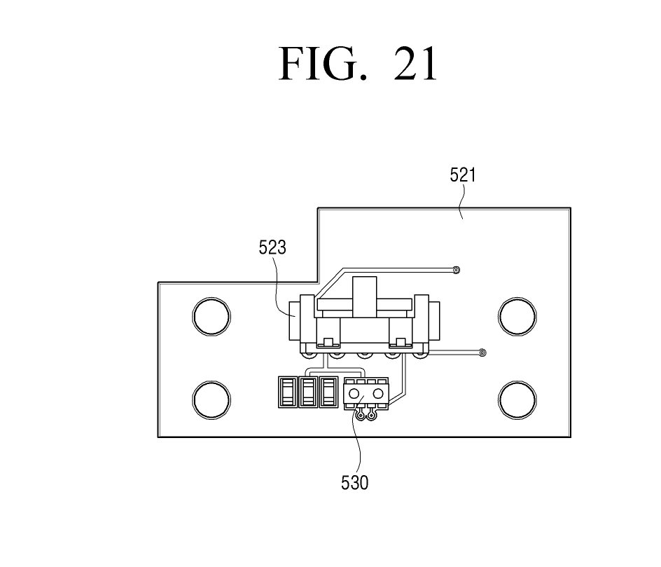

FIG. 21 is a view illustrating an example switch board 521.

Referring to FIG. 21, the switch board 521 may include the limit switch 523 and the proximity sensor 530. The limit switch 523 makes the shaft 502 rotated only in the case where the knob 523a is within a predetermined range to prevent the endless rotation of the shaft 502.

The proximity sensor 530 outputs a value based on a distance that an object approaches. For example, if the object is farthest apart, the proximity sensor 530 may output a first output value (e.g., 185), whereas if the object approaches closest, the proximity sensor 530 may output a second output value (e.g., 2547).

In an example of the disclosure, although it is described that the distance is measured by the proximity sensor 530, the proximity sensor 530 may be replaced by another sensor. For example, whether the object approaches may be determined using an optical sensor, an ultrasonic sensor, or an infrared sensor, or the like.

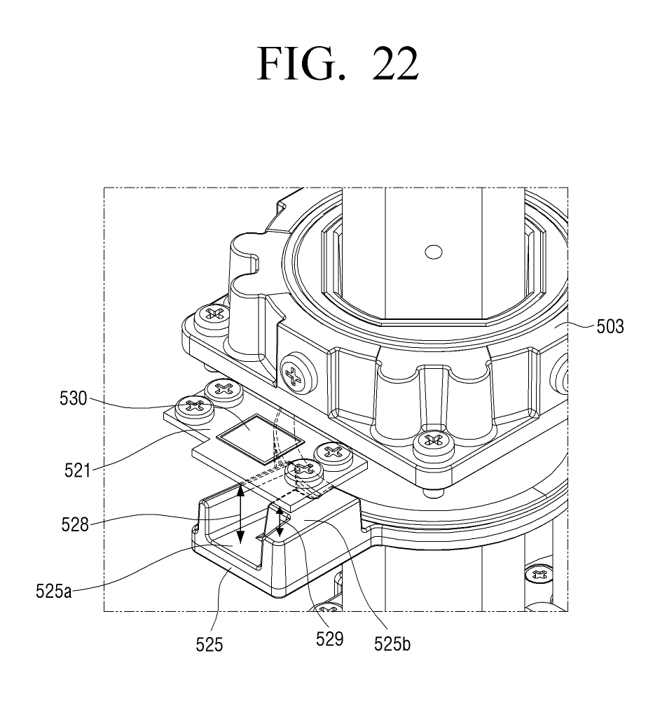

FIG. 22 is a view illustrating a distance between step portions 525 based on the position of a switch board 521.

A sensor portion, for example, the proximity sensor 530, may be located on the switch board 521. The sensor portion may be installed on the switch board, and may be configured to detect a distance between the switch board and the surrounding structure based on the rotation of the shaft.

The step portion 525 may include first and second planes 525a and 525b having different heights with respect to the proximity sensor 530. The distance 528 between the first plane 525a and the proximity sensor is longer than the distance between the second plane 525b and the proximity sensor 530.

As the shaft 502 is rotated, the switch board 521 is rotated, and as the switch board 521 is rotated, the distance between the proximity sensor 530 included in the switch board 521 and the step portion 525 may be changed, and thus the output value of the proximity sensor 530 may change accordingly.

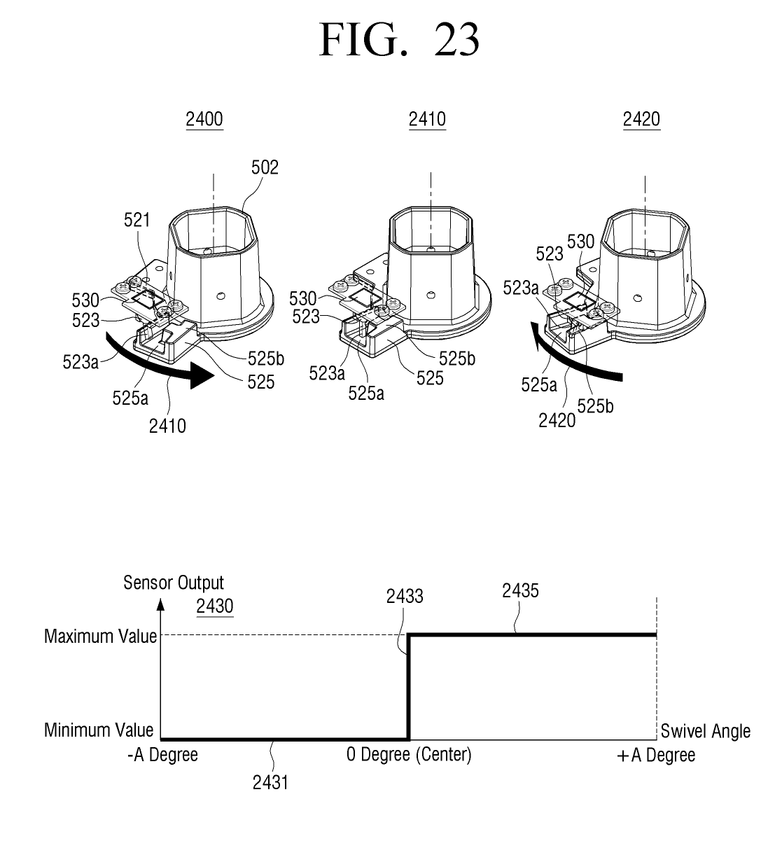

FIG. 23 is a view illustrating output values of a proximity sensor 530 based on rotation of a switch board 521.

Referring to FIG. 23, a state 2400 where the shaft 502 is rotated up to a left limit point, a state 2410 where the shaft 502 is positioned in the center, and a state 2420 where the shaft 502 is rotated up to a right limit point are illustrated, and a graph 2430 illustrating respective output values 2431, 2433, and 2435 of the proximity sensor 530 based on the positions 2400, 2410, and 2420 of the shaft 502 are shown.

The shaft 502 may be rotated from −A° to +A° about a center 2410. For example, the shaft 502 may be rotated from −8° to +8° about the center 2410.

When the shaft 502 is at a position of −8° (2400), the proximity sensor 530 detects the first plane 252a, and thus the distance between the proximity sensor and the step portion becomes maximized. In this case, the proximity sensor 530 may output the minimum value (e.g., 185). As described above, when the shaft 502 is at the position of −8° (2400), the knob 523a may be pivoted rightward. The shaft 502 is not rotated any more as the knob 523a of the limit switch 523 is pivoted rightward.

When the shaft 502 is rotated counterclockwise at the position of −8° (2400) and is put at the center position (2410), the knob 523a may be positioned at a middle position. In this case, the output value of the proximity sensor 530 may be, for example, 2547. When the shaft 502 is continuously rotated counterclockwise at the center position (2410) and is put at a position of +8°, the knob 523a may be pivoted leftward. In this case, since the proximity sensor 530 detects the second plane 523, the distance between the proximity sensor 530 and the step portion becomes minimized, and thus the proximity sensor 530 may output the maximum value (e.g., 2547). In this case, the shaft 502 is not rotated any more as the knob 523a of the limit switch 523 is pivoted leftward.

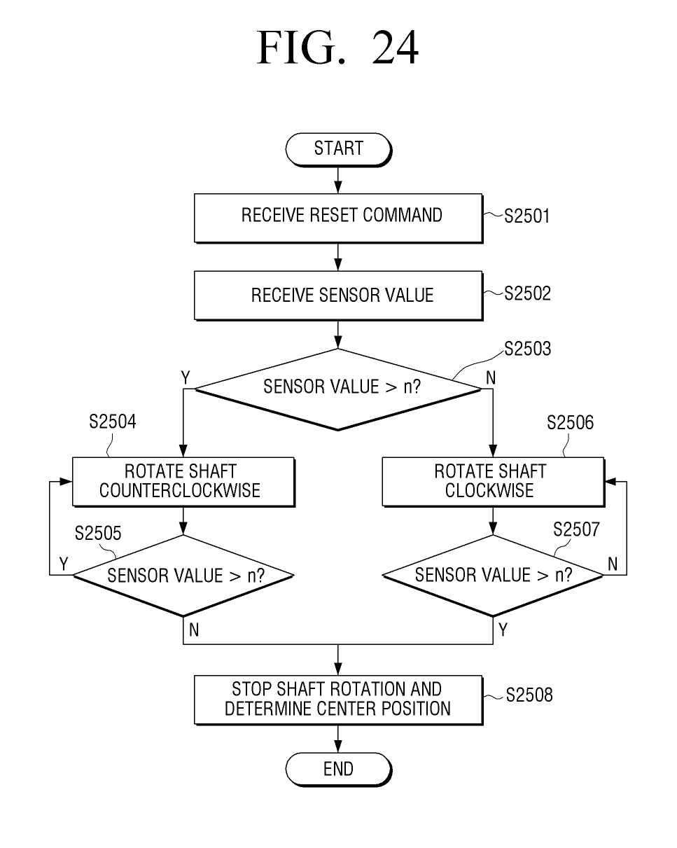

FIG. 24 is a flowchart illustrating an example process in which a shaft 502 is set to a center position (2410).

The shaft 502 may be rotated by a remote controller (not illustrated), and may be rotated within a predetermined angle range controlled by the limit switch 530. For example, the shaft 502 may be rotated within the range of +8° to −8° about the center. If a user rotates the shaft 502 using the remote controller, stops the rotation at a predetermined position, and then presses a reset button, the controller 1001 may be configured to receive a reset command (S2501), and may return the shaft 502 to the center position 2410.

The controller 1001 may be configured to determine the rotation direction of the shaft 502 based on the output value of the proximity sensor 530. For example, if the output value of the proximity sensor 530 is larger than a predetermined value, the controller 1001 rotates the shaft 502 clockwise. While rotating the shaft 502 clockwise or counterclockwise, the controller 1001 may be configured to check the output value of the proximity sensor 530, and if the output value of the proximity sensor 530 is changed, to stop the rotation of the shaft 502, and to determine the current position as the center position 2410. A process of driving the shaft 502 as described above will be described in order.

The controller 1001 receives the output value from the proximity sensor 530 (S2502), and then compares the output value of the proximity sensor 530 with a predetermined value n (n is a natural number) (S2503).

If the output value of the proximity sensor 530 is larger than n, the controller 1001 is configured to rotate the shaft 502 counterclockwise (S2504), to continuously receive the output value of the proximity sensor 530 while the shaft is rotated, and to compare the received output value with the predetermined value n (S2505). If the output value of the proximity sensor 530 is larger than n, the controller 1001 is configured to continuously rotate the shaft 502 counterclockwise, whereas if the output value of the proximity sensor 530 is smaller than n, the controller 1001 is configured to stop the rotation of the shaft 502, and to determine the current position as the center position 2410 (S2508).

On the other hand, if the output value of the proximity sensor 530 is smaller than n (S2503), the controller 1001 is configured to rotate the shaft 502 clockwise (S2506). The controller 1001 is configured to receive the output value of the proximity sensor 530 while continuously rotating the shaft 502 clockwise, and to compare the received output value with the predetermined value n (S2507). If the output value of the proximity sensor 530 is larger than n, the controller 1001 is configured to continuously rotate the shaft 502 counterclockwise, whereas if the output value of the proximity sensor 530 is smaller than n, the controller 1001 is configured to stop the rotation of the shaft 502, and to determine the current position as the center position 2410 (S2508).

While the disclosure has been described in connection with the certain examples illustrated in the drawings, they are merely illustrative, and the disclosure is not limited to these examples, but various equivalent modifications and variations of the examples can be made by a person having an ordinary skill in the art to which the disclosure pertains. For example, the proximity sensor 530 that is used to determine the center position 2410 of the shaft 502 may be replaced by another sensor that can measure the distance. For example, the proximity sensor 530 may be replaced by an optical sensor, an ultrasonic sensor, or an infrared sensor, or the like.

The operations according to the examples of the disclosure may be implemented by the single controller 1001. For example, program commands for performing operations implemented by various computers may be recorded in a computer readable medium. The computer readable medium may include program commands, data files, and data structure singly or in combination. The program commands may be specially designed and configured for the disclosure or may be known to those skilled in the art to be usable. Examples of the computer readable recording medium include a magnetic medium, such as a hard disc, floppy disc, or a magnetic tape, an optical recording medium, such as CD-ROM or DVD, a magneto-optic medium, such as a floptical disk, and a hardware device specially configured to store and perform program commands, such as a ROM, RAM, or a flash memory. Examples of program commands include not only machine language codes made by a compiler but also high-class language codes that can be executed by a computer using an interpreter or the like. In the case where a part or the whole of the constituent elements described in the disclosure is implemented by a computer program, the computer readable recording medium in which the computer program is stored is included in the present disclosure.

Accordingly, the scope of the disclosure should not be limited to the example embodiments as described above, but should be defined by not only the claims to be described after but also equivalents of the claims.

What is claimed is:

1. A display device comprising:
a main body including a signal processor configured to output audio and video signals, a display configured to display the video signal, and a controller; and
a drive body electrically connected to the main body and configured to rotate the main body leftward and rightward and to support the main body;
wherein said drive body includes an upper plate configured to form an upper surface of the drive body and configured to ascend and descend.

2. The display device as claimed in claim 1, wherein the upper plate is configured to ascend or descend based on at least one of: a power-on/off of the display device and a user input.

3. The display device as claimed in claim 1, wherein the drive body comprises light emitting circuitry configured to emit light through a gap between an upper end of the drive body and the upper plate when the upper plate ascends.

4. The display device as claimed in claim 1, wherein the drive body comprises:
a support member connected to a rear surface of the main body;
a shaft configured to rotate the main body leftward and rightward;
a shaft cover configured to cover the shaft and to guide ascending and descending of the upper plate; and
a connector configured to connect the shaft and the support member to each other.

5. The display device as claimed in claim 4, wherein the drive body further comprises:
a second speaker configured to output at least a portion of the audio signal that is output from the main body; and
a power supply configured to supply a power to the main body and the drive body.

6. The display device as claimed in claim 5, wherein the drive body comprises a lower plate, and
at least one hole disposed in the lower plate for discharging sound that is output from the second speaker to an outside of the drive body.

7. The display device as claimed in claim 1, wherein the upper plate comprises light emitting circuitry that is coupled along an edge of a bottom surface of the upper plate, and
the controller is configured to control the light emitting circuitry to emit light during movement of the upper plate.

8. The display device as claimed in claim 1, wherein the drive body further comprises a weight body configured to move a center of gravity of the drive body, and
the weight body is located at a lower end of the drive body.

9. The display device as claimed in claim 4, wherein the drive body further comprises a drive portion,
the drive portion comprising:
a first actuator configured to move the upper plate; and
a second actuator configured to rotate the shaft.

10. The display device as claimed in claim 4, wherein one side of the shaft is coupled to a worm gear, and the worm gear is coupled to a dummy gear that supports the shaft.

11. The display device as claimed in claim 10, wherein a reinforcement member for supporting the shaft is arranged around the second actuator and the shaft.

12. The display device as claimed in claim 5, wherein a vibration plate of the second speaker is disposed to face a lower plate of the drive body.

13. The display device as claimed in claim 1, wherein the main body comprises a rear cover provided to cover a rear chassis of the main body, and
first, second and third holes formed in the rear cover and configured to dissipate heat generated from an inside of the main body to an outside of the main body.

14. The display device as claimed in claim 13, wherein the first, second and third holes are formed in an upper portion and a lower portion of the rear cover in a width direction of the rear cover, and are directed in different directions.

15. The display device as claimed in claim 4, further comprising a sensor assembly arranged around the shaft to sense rotation of the shaft.

16. The display device as claimed in claim 15, wherein the sensor assembly comprises:
a switch board fixed to one side of the shaft; and
a first sensor disposed on the switch board and configured to detect a distance to a structure around the switch board based on the rotation of the shaft.

17. The display device as claimed in claim 15, wherein the sensor assembly further comprises a second sensor disposed on the switch board to limit an angle of leftward and rightward rotation of the shaft.

18. The display device as claimed in claim 17, wherein the second sensor comprises a limit sensor that operates with a part thereof configured to interfere with a structure around the switch board based on the rotation operation of the shaft.

19. A display device comprising:
a main body provided with a display panel; and
a drive body electrically connected to the main body and configured to rotate the main body leftward and rightward and to support the main body;
wherein said drive body includes an upper plate configured to form an upper surface of the drive body and to ascend or descend separated from the drive body.

20. A display device comprising:
a main body including a signal processor, a first speaker, a display, and a controller;
a drive body coupled to the main body and including a drive portion configured to rotate the main body leftward and rightward on the basis of a signal output from the controller, a power supply configured to supply a power to the main body, a second speaker configured to output at least a portion of an audio signal output from the signal processor, and light emitting circuitry configured to emit light based on a signal output from the controller; and
an upper plate configured to form an upper surface of the drive body and to ascend or descend separated from the drive body,
wherein the light emitting circuitry is configured to emit light when the upper plate ascends.
